(19) United States
(12) Patent Application Publication
(10) Pub. No.: US 2018/0232192 A1
(43) Pub. Date: Aug. 16, 2018

(54) System and Method for Visual Enhancement, Annotation and Broadcast of Physical Writing Surfaces

(71) Applicants: Samson Timoner, Cambridge, MA (US); Wai Kit Lau, Chestnut Hill, MA (US)

(72) Inventors: Samson Timoner, Cambridge, MA (US); Wai Kit Lau, Chestnut Hill, MA (US)

(21) Appl. No.: 15/432,248

(22) Filed: Feb. 14, 2017

(51) Int. Cl. G06F 3/14; G06T 3/00; G09G 3/00; G09G 3/20; G09G 5/12; G09G 5/391; H04N 17/02; H04N 9/31

(52) U.S. Cl. CPC G06F 3/1446; G09G 2360/04; G09G 3/002; G09G 3/20; G09G 3/2003; G09G 3/2092; G09G 5/12; G09G 5/391; H04N 17/02; H04N 9/31; H04N 9/3147; H04N 9/3188; G09G 2300/026; G09G 2320/02; G09G 2320/0666; G09G 2320/0693; G09G 2320/10; G09G 2340/0414; G09G 2340/0421; G06T 3/0093

(57) ABSTRACT

The invention includes a method and system to visually capture, enhance, broadcast, annotate, index and store information written or drawn on physical surfaces. A user points a camera at a whiteboard and broadcasts the video stream so that other users can easily receive and collaborate remotely in multi-user fashion. The system enhances the video by leveraging the nature of video as a multitude of related frames over time and by leveraging the nature of writing, and/or the nature of the written surface in the video stream. Annotation tools, and real-time data sharing such as mouse-location facilitate multi-user collaboration. Also facilitating collaboration are archival functionalities that make it possible to review previous work, and search through older writings and annotations.

The system addresses many writing surfaces including whiteboards, blackboards, glass, paper and other tangible surfaces. The nature of each surface is different—that is they have distinct properties and the algorithms can be tuned for each such surface. The writing on the surface and/or the surface is enhanced to improve the legibility of the writing. The algorithms within can also be made to adapt to available computational and bandwidth resources.

The video is sometimes distributed by relaying the video through one or more central computers. It can be sent peer-to-peer, sometimes relayed from person to person. Depending on the number of people on the call, and the bandwidth and processing power available, different options may be preferable.

The software system allows any camera pointed at a physical writing surface to perform all the functionalities above, so that users can easily collaborate remotely in a full-duplex, multi-party fashion. The broadcasting user will come to a website, which will access his web camera and broadcast the video stream to other users, who will watch on a website.

### FIELD OF THE INVENTION

This invention is related to improving the fidelity and functionality of sharing physical written surfaces such as whiteboards, blackboards, paper and other writing surfaces, via video. It is focused on, but not exclusive to, visual enhancement, annotation, transcription, metadata enrichment, storage and broadcast of information on any type of physical writing. More particularly, it focuses on enhancing the readability of the information, enriching metadata about the images and overlaying additional collaborative functionalities on the writing surface once the video images are captured.

### CROSS-REFERENCE

This application claims the benefit of U.S. Provisional Application Ser. No. 62/295,115 filed Feb. 14, 2016, entitled SYSTEM AND METHOD OF CALIBRATING A DISPLAY SYSTEM FREE OF VARIATION IN SYSTEM INPUT RESOLUTION, the entirety of which is herein incorporated by reference.

### BACKGROUND OF THE INVENTION

Remote collaboration is often facilitated using video or audio conferencing or screen sharing. In such a meeting, it is often beneficial to explain a concept by drawing a quick diagram or written explanation. On most computers, it is time consuming and difficult to make simple sketches, and the results often look pixelated. It is faster and easier and more precise to draw by hand with a pen or marker, so that paper or a whiteboard is a preferred medium for making sketches. Alas, if one uses paper or a whiteboard, it becomes challenging to digitally share the on-going sketch with remote users.

One solution is to point a videoconference camera at the whiteboard. This method has a few shortcomings. The image quality of the writing is often insufficient due to issues including glare, poor lighting, distance from the whiteboard, and noise inherent in the camera. Remote viewers often can't read the writing.

Another solution that has been tried is a method that improves the quality of a single image. That solution can work well for processing a single frame of a drawing session, but doesn't meet the real-time needs of a video session, and doesn't take advantage of the data in time.

If remote viewers can read the writing in the video imagery, they often desire a way to point at, reference or annotate areas of the written surface to guide the conversation and interact. As such, sending the video alone is valuable, but does not solve the full collaboration problem.

This patent describes a system and method that addresses these shortcomings.

### SUMMARY OF THE INVENTION

The invention includes a method and system to visually capture, enhance, enrich, broadcast, annotate, index and store information written or drawn on physical surfaces. A user points a camera at a whiteboard and broadcasts the video stream so that other users can easily receive and collaborate remotely in multi-user fashion. The system enhances the video by leveraging the nature of video as a sequence of related frames over time and by leveraging the nature of the writing, and the writing surface. Multi-user collaboration is facilitated by annotation tools, allowing users to add text and draw digitally on a video. Also facilitating the collaboration is an archival feature that saves a frame, a subset of or the whole video locally on the user's computation device, or to our own or third-party servers in the cloud.

Initially, the system uses a web browser to broadcast and receive video. Users visit a website and configure their system through the browser. The system initially supports cameras embedded in a computer such as a laptop, cell phone or tablet, or cameras connected to those devices such as a USB webcam. In many cases, the user points a camera at the beginning of the meeting. In other cases, the camera is mounted and set up once, so that no subsequent setup is necessary.

The system addresses many writing surfaces including whiteboards, blackboards, glass, paper and other physical surfaces. Each surface has distinct properties and the algorithms can be tuned for each such surface. The writing on the surface and the surface itself are enhanced to improve the legibility of the writing.

The algorithms can also be made to adapt to available computational and bandwidth resources.

The video is sometimes distributed by relaying through one or more central computers. It can be sent peer-to-peer, sometimes relayed from person to person. Depending on the number of people on the call, and the bandwidth and processing power available, different options may be used.

The software system allows any camera pointed at a physical writing surface to perform all the functionalities above, so that users can easily collaborate remotely in a full-duplex, multi-party fashion. The broadcasting user will come to a website, which will access his web camera and broadcast the video stream to other users, who will watch on a website.

### BRIEF DESCRIPTION OF THE DRAWINGS

The invention description below refers to the accompanying drawings, of which:

FIG. 1 is a diagram of an exemplary setup in accordance with a generalized embodiment of this invention.

FIG. 2 is an exemplary flow diagram of the hardware architecture and data flow in according with the invention.

FIG. 3 shows the high-level software architecture of the invention consistent with the teachings of the invention.

FIGS. 4a, 4aa, 4b, 4c, 4d, 4e, 4f show a photograph of an exemplary graphical user interface (GUI) in according with a generalized embodiment of the invention. FIGS. 4aa,4b, 4c,4d, and 4df are zoomed in, and do not show the entire interface.

FIG. 5 shows a block diagram to describe an exemplary video capture, processing, and transmission module in accordance with an embodiment of the invention.

FIG. 6a shows an exemplary flow diagram for the annotation module. FIG. 6b shows an exemplary annotation module GUI.

FIG. 7 shows a block diagram illustrating an exemplary instantiation of the archival module.

FIG. 8 shows a block diagram of an exemplary display module.

FIGS. 9a, 9b, 9c shows some of the factors that affect the quality of the image to be processed.

FIG. 10 shows a block diagram of an exemplary process video step from FIG. 5.

FIGS. 11a, 11b,11c,11d are block diagrams of example initial processing steps to find noise, writing regions, surface types, and the input/output curve of the camera system

FIGS. 12a, 12b, 12c show an algorithm that finds and applies gain detection.

FIGS. 13a and 13b shows a family of memory-less processing.

FIG. 14a shows an exemplary flow diagram illustrating an exemplary instantiation of the invention. FIG. 14b shows a method for calculating the parameters in an enhancement algorithm

### DETAILED DESCRIPTION: IMAGE PROCESSING TECHNIQUES

Without limitation, here are some methods and concepts that form the basis of the algorithms for image enhancement. In each case, one example of how to use the algorithms is presented. A person skilled in the state of the art can expand on them straightforwardly.

Backgrounding.

A common way to identify pixels that have changed is the Stauffer-Grimson knn backgrounding, published as: Chris Stauffer and W. E. L Grimson. Adaptive background mixture models for real-time tracking. In Computer Vision and Pattern Recognition, volume 2, pages 252-258, 1999, the entirety of which is hereby included by reference. The concept is that for a single pixel, there are multiple clusters of values. In this case, that is the background (e.g. writing surface), writing, obstruction, etc. Each cluster is represented as a Gaussian distribution. Whenever a value for a new pixel comes in, if it is within 2.5 standard deviation of the known values, it is accepted into that cluster. If not, a new cluster can be created. The goal of the algorithm is to classify what the pixel is currently representing. The algorithm is part of a class of Gaussian Mixture Model algorithms (GMM). The backgrounding algorithm is noisy, so it is typically used in conjunction with a blob-region detection or blob-finding algorithm.

Blob-Detection/Region-Finding Algorithm.

For pixels in a particular class, e.g. background, some of those pixels that are found will be next to other pixels of the same class, and grouped into a region. For pixels classified to be obstructions: the largest regions will be considered obstructions, while the smallest regions can be ignored. For example, regions of size 3 pixels or less, can be ignored as noise. Similarly, large regions often have holes that can be filled in. Sometimes the regions are dilated and then eroded to smooth out the edges. These are morphological operators on binary images. These steps taken that are called region finding algorithms are blob detectors. Region-finding algorithms can also be run on grayscale/color images. In this case, pixels are clustered together if they are similar to their neighbors. As an example, a simple similarity methodology is to check if the intensity is within 20% of a neighbor's intensity.

Low-Pass Filter.

A type of digital filter that is convolved with the image. Commonly used to remove spatial variations in the data, and to reduce noise. It is very effective on writing surfaces where the intensity variations are slowly varying. The exceptions are writing, obstructions and boundaries. A common low pass filter is a Gaussian low pass filter. Low pass filters can be used in space, time and/or both.

High-Pass Filter.

High-pass filters are digital filters that select for fast-changes. These filters are often used to look for writing or the boundaries of the writing surface. These filters are often very sensitive to noise, so that running filters in time (e.g. a low-pass filter in time, before a high-pass filter in space) are extremely helpful to improve the signal to noise ratio of these filters. An effective example is to low-pass filter an image, and subtract the result from the original image. One can design a high-pass filter using a Parks McClellan algorithm or other filter algorithm that focuses on enhancing high spatial frequencies. Note that sometimes one is interested in high spatial or temporaral frequencies, but not the highest frequencies which are the noisiest. In this case, the filter is still a high pass filter, though it is sometimes called a band-pass filter. It is a filter that passes a specified range of frequencies.

Max/Min Filter.

For every pixel, look in a region around that pixel, and replace it with the maximum; this is the max filter. The min filter is formed likewise using the minimum. They are often done with total intensity, or on each color channel. These filters are particularly useful for dealing with camera intensity falloff on white surfaces. With intensity variations, one wants to make comparisons against the local intensity, not against global intensity. For a white surface, the max filter gives a measure of the local intensity. The min filter is useful for finding the writing on whiteboards. To reduce noise, one often ones uses a max filter followed by a min (or vice versa) to reduce noise. Also, low-pass filtering first is useful to reduce the effects of noise. That can be done spatially and/or in time. Note that the correct filter to use clearly depends on the type of surface being used. For background on blackboards and other dark surfaces, one uses the min filter first to find the background intensity. These filters are examples of morphological operators on grayscale images. Note that sometimes the morphological operators are applied using regions that look like lines. One can use them to find stroke-like objects.

Spline Based Intensity Fitting.

One can fit a spline to the overall intensity of the writing surface, and then use it to normalize the surface intensity in order to make global comparisons. One has to be very careful to fit the spline. Often one can run a filter to determine average intensity locally. A robust average intensity metric is often better.

Robust Metrics.

Robust metrics are measures that are robust to noise, and in particular outliers. There are many robust metrics that are commonly known to the machine learning community. In many of them, one tries to do outlier detection. As one example, one can form a histogram of a range of values and looks for the mode, the peak in the data. One can then cluster the data, and omit the data not in the cluster. For example, for a writing surface to find the average intensity in a region, one might want to ignore the writing, which might have very different intensities than the background writing surface. To achieve this, form a histogram of all the values, and look for a cluster, and throw away the remaining data. There are many clustering techniques. A simple example of one is to start at the peaks in the histogram and move in each direction until the value of the peak has subsided to half or a third of the peak value. More complicated clustering methods consider the relative width of the cluster of data, and the relative distance between adjacent samples.

Noise Measurements.

One can examine a pixel in time, and find the mean and standard deviation in time. The standard deviation estimate is very noisy, so sometimes one averages a number of measurements together spatially to improve the measure. Though, one must be careful in spatially averaging as the standard deviation of many cameras is dependent on the intensity of the pixel.

Color/Intensities.

We work in many color spaces including:
RGB: Red, Green Blue
YCbCr: Luma, blue-difference, red-difference
YUV: Luma and two chrominance channels
HSV: Hue, Saturation, Value
R+G+B, R−G, B−G: Total intensity, red-difference, blue-difference.

Histogram Techniques:

We often form one, two or three-dimensional histograms. For these histograms, we take the data and look for clusters and/or thresholds. In each of these spaces, we can form histograms: counts of how many data points have a specific set of parameters. We can then look for peaks in the histogram and peak widths to form thresholds around these peaks. Peaks are the bins with the largest counts. Their widths can be measured in many ways, such as examining nearest bins until one find a bin with height less than half the peak height.

Segmentation:

For a whiteboard, one can find the histogram of intensities across an image of a whiteboard. One might use a max-min filter first to gain an estimate of local intensity, and then normalize the image and then histogram. One would expect the writing surface to have a near uniform intensity and be large. One can therefore find the largest peek in the histogram, for a whiteboard one can threshold all intensities as higher as likely being part of the writing surface. This is one method to make sure glare regions are not ignored. One can then use region-finding methods to find the whiteboard. One can use the estimates of noise to decide that the threshold can actually be lower by one or two standard deviations than the peak of the histogram. There are many variants on these algorithms, including methods that do region finding based on intensity similarities to neighbors, and not crossing edges. One can start by finding numerous connected regions, and then determining, based on size, uniformity of color, presence of writing, and location in the camera, which region is most likely to be the surface of interest.

Writing/Text Detection.

There are a number of algorithms such as the one by Neumann et. al (Neumann L., Matas J.: Real-Time Scene Text Localization and Recognition, CVPR 2012) or MERS (Chen, Huizhong, et al. “Robust Text Detection in Natural Images with Edge-Enhanced Maximally Stable Extremal Regions.” Image Processing (ICIP), 2011 18th IEEE International Conference on. IEEE, 2011.), the text of each is included here by reference. A simple algorithm is to use the backgrounding algorithm to do text detection, and then use a region-connection algorithm. Another method is to use a multi-dimensional histogram based on measures of edges, and intensity and color, and cluster pixels into connected regions or strokes.

Edge-Measurement/Degree of Edge:

There are numerous ways to make measures of edges. A difference of linear Gaussian filters is a common technique; they effectively form a band-pass filter. A Canny edge-filter is also common used. Yet another method is a high-pass filter. The morphological operators on grayscale images with regions that are shaped like lines also yield a measure. Note that the magnitude and sign of these methods is interesting. For many measurements of the degree of edge, the results have a different sign if just outside a dark region, then just inside a dark region. To enhance writing or background, one can enhance these regions based on sign. One can also choose not to enhance regions whose degree of edge is too small.

Boosting.

The concept is to chain together many simple algorithms. Typically each one has a high false-positive rate, and a very low false negative rate. If you apply many of these algorithms over and over again, each time some of the false positives are removed. One chains enough algorithms so that the overall result is an algorithm that has a very low false negative rate, and a very low false positive rate. One can use algorithms based on histograms to achieve the desired results. One can use this concept over and over again in segmentation, applying thresholds in many different spaces to get a good result.

### I. Illustrative Embodiments

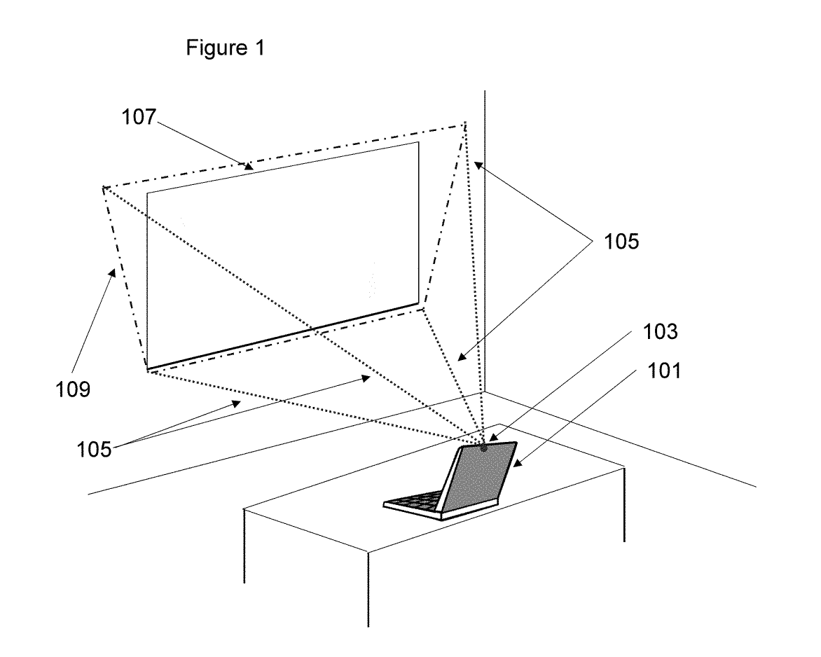

FIG. 1 shows an illustrative setup of a system that will be used in this invention. A laptop, 101, has an embedded camera in it 103. The camera is viewing the wall, with a whiteboard 107 on it. The viewing pyramid of the camera is shown with lines 105. The view of the camera on the wall is shown by the dashed outline 109, which will become the camera image. The view is trapezoidal, it is not square to the screen, and perhaps suffers from other distortions such as radial distortions. The camera 103 captures video of the whiteboard and transmits it to remote viewers.

The camera, 103, captures a video stream that can be transmitted to remote viewers. The video is generally a sequence of image frames captured at a regular rate, such as 30 frames per second. The rate is typically uniform, but it can vary. It can also be adjusted depending on the bandwidth available to transmit, and the available computation to compress the video for transmission. Some cameras have ‘photo mode’ which produces a still image of higher quality than the default video. One can effectively take still images many times sequentially to form a video stream.

Note that the camera 103 need not be embedded. It could be an attached device, such as a camera connected to the laptop via a USB camera (often referred to a “webcam”). Or it could be an IP camera connected via a wired or wireless data network (not shown).

The laptop 101 can enhance the video before transmission, taking advantage of the expected qualities of the writing on the surface. Enhancement means improving the clarity and legibility of the writing on the written surface. The goal is to improve a visibility or readability metric. Two examples of readability metrics are per-pixel signal to noise ratio, and the average size, intensity and count of spurious edges after enhancement. A common goal is to amplify the difference between the intensity of the writing and the background, and to reduce the overall noise.

The enhancement is typically done to compensate for many factors. Example enhancement goals include reducing the effects of noise, compensating for properties of the camera lens such as low-pass filtering caused by the lens and artifacts in the camera from compression and processing of the camera video. Enhancement is also done to compensate for factors in the room that make the writing surface less clear, or skew caused cause by the positioning of the camera. Enhancement can be done to minimize the bandwidth that will be required to transmit the video. Or for transmission, it can also done to anticipate and avoid artifacts caused by compression and/or transmission.

Note the laptop, 101, can more generally be any type of computer. The computer will most often use a central-processing unit (CPU) such as the Intel Core processor family of CPUs (Intel Inc. Santa Clara, Ca) and/or a graphics processing unit (GPU) such as the Quadro family of GPUs (NVIDIA Inc, Santa Clara, Ca). The computer needs to be able to access video from the camera, and transmit the video remotely. For the case of a computer with a display such as a laptop, the video is also displayed locally.

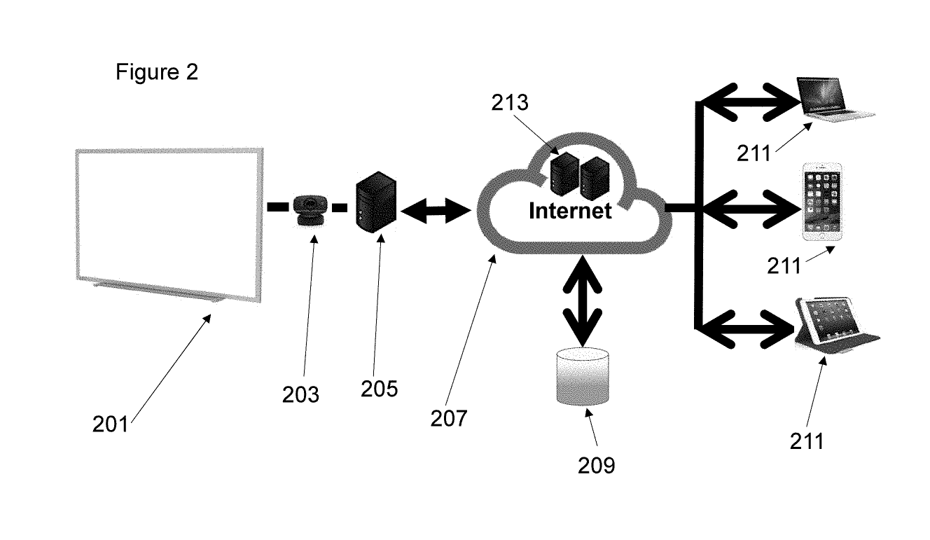

FIG. 2 is an exemplary flow diagram of the hardware architecture and data flow in according with the invention. There is a writing surface 201, indicated in the diagram by a whiteboard. There are many types of writing surfaces including paper, notebooks, blackboards, whiteboards, a wall painted with IdeaPaint (IdeaPaint, Inc. Boston, Mass.), etc. Camera 203 captures the writing surface in a video. The video is processed by a computer 205 for possible enhancement and encoding for transmission. If the computer has a display, such as laptop 101 in FIG. 1, the video can be displayed locally. The video is broadcast to other computers, such as through network connection, wired or wireless, and through the Internet, 207.

The video can be transmitted peer-to-peer to one or more devices 211 including laptop, cell phone and tablet shown for reference. Or, the video can be relayed through computers 213 connected via the Internet. For example, if the network bandwidth from 205 is limited, the computer 205 can broadcast the video to a computer 213, which can broadcast to other computers 213, which can then broadcast to the devices 211. Similarly, the devices 211 can be used as a video relay, receiving the video and re-broadcasting to other devices 211.

The data can be archived which is indicated as a cylinder in 209. Note that the archival system may have a processor associated with it to processor data before archival.

In FIG. 2, the arrows go both ways between the devices 211 and the archival 209. Users may augment and annotate the data and share additional written surface and other data with others, which may be archived. Also, previous archival data may be shown in the same interface as the written surface. Also, not shown, devices 211 may have their own processing and cameras, and may contribute a video stream to the collaboration. That is, they may effectively take the role of 203 and 205.

The enhancement processing may be done in computer 205. It may be done at any point in the process. That is, it might be done before broadcast. It may be done by a computer(s) 213, or receiving devices 211. There is clearly a trade-off between where the computation is done, and the bandwidth available to transmit the results of the computation.

The computers 213 may perform additional duties. For example, for peer-to-peer connections between the devices 211, and between 205 and the devices 211, it is helpful to have a mediation computer to transmit data so that the computer may transmit data to form that connection. Such a computer is often called a signaling computer. The WebRTC standard (WebRTC 1.0: Real-time Communication Between Browsers, W3C Working Draft 10 Feb. 2015, Bergkvist et. al, The World Wide Web Consortium (W3C)) provides good background information on how to form such connections and how to use a signaling computer, which is well known in the state-of-the-art, and is included by reference. The computers 213 can also handle permissions, e.g. who is allowed to log in, as well as invitations. They can handle user presence detection, e.g. who is currently taking part in the written communication session, and reporting that information to users.

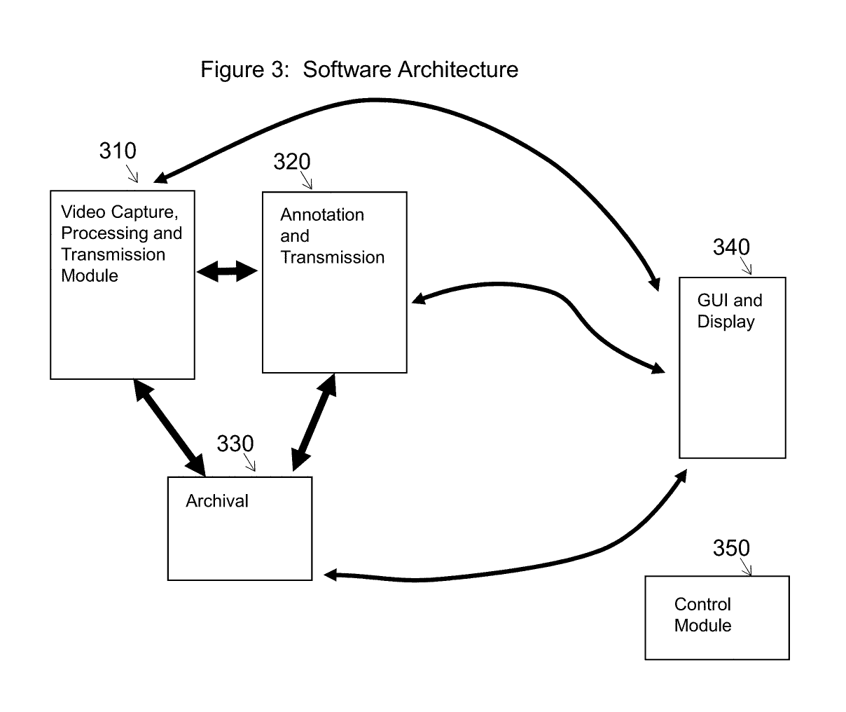

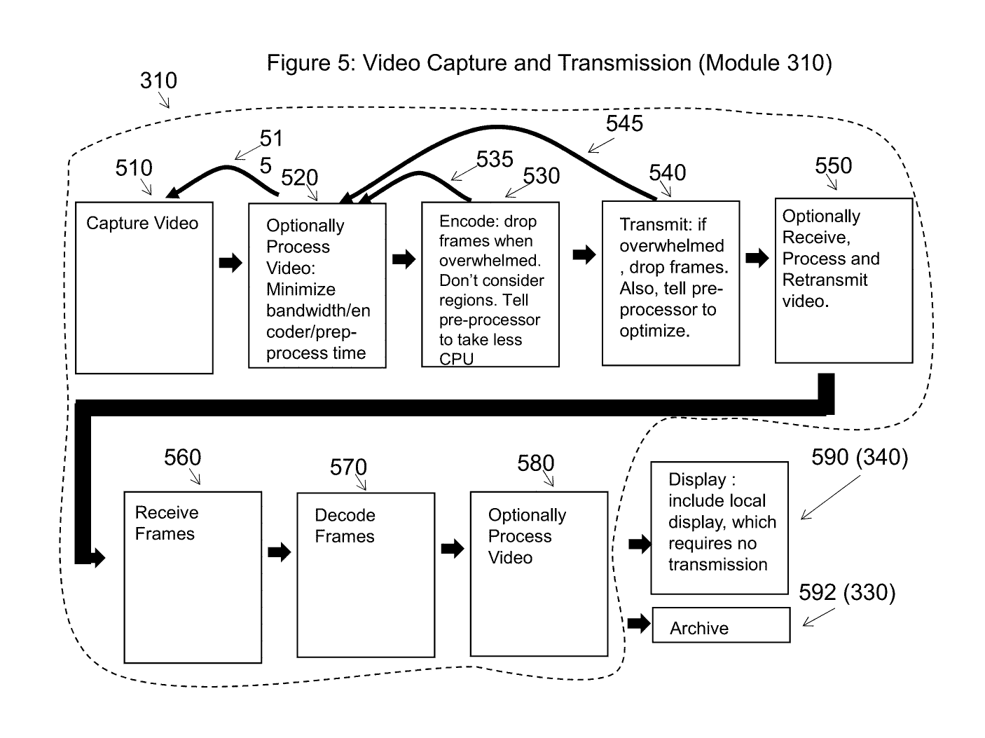

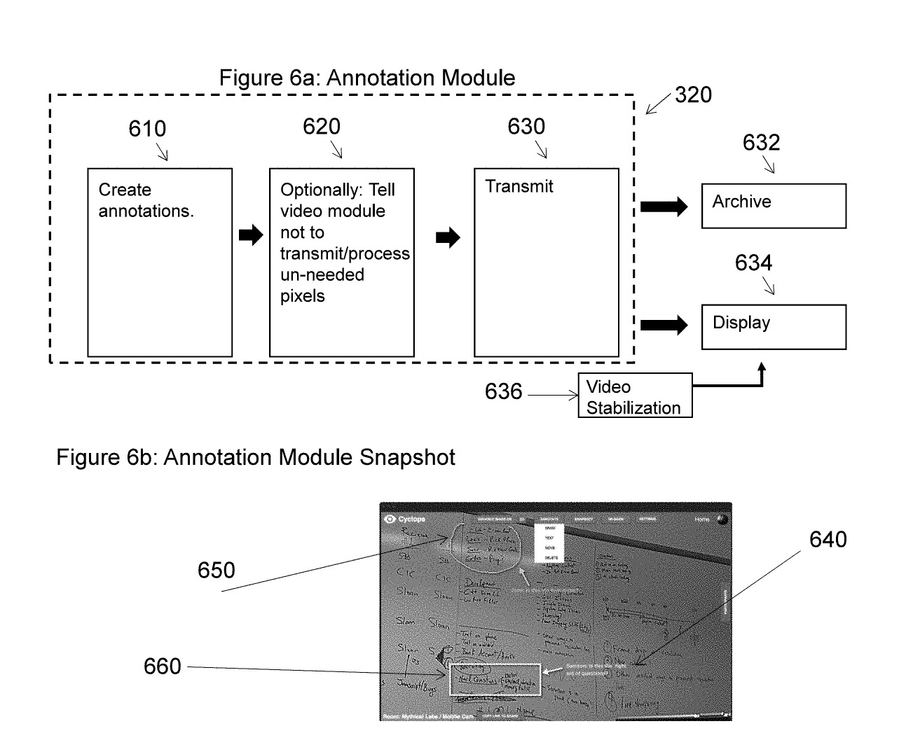

FIG. 3 shows the high-level software architecture of the invention. Module 310 is the video capture and processing module. The camera is controlled to capture the video. The video is processed and transmitted. Processing may include enhancement, salient feature detection, obstruction removal, etc. It helps to optimize bandwidth usage as well as working within the available computational resources. The video, or features from the video can be archived in module 330. The annotation module 320 enables the addition of additional notes and simple shapes and drawings on top of the video. The annotations are transmitted back and forth between users, and can be archived in module 330. The graphical user interface and the display 340 take data from the video capturing module, the annotation model and the archival model and displays them. The GUI also allows the tuning of display algorithms or processing algorithms to optimize for a particular devices' display. Note that FIGS. 5, 6,7,4a show exemplary instantiations of 310, 320,330,340 respectively.

There is also a control module 350 that helps orchestrate the entire system. That includes, but is not limited to, helping to set up communications between the devices. It includes doing presence detection, and permissions.

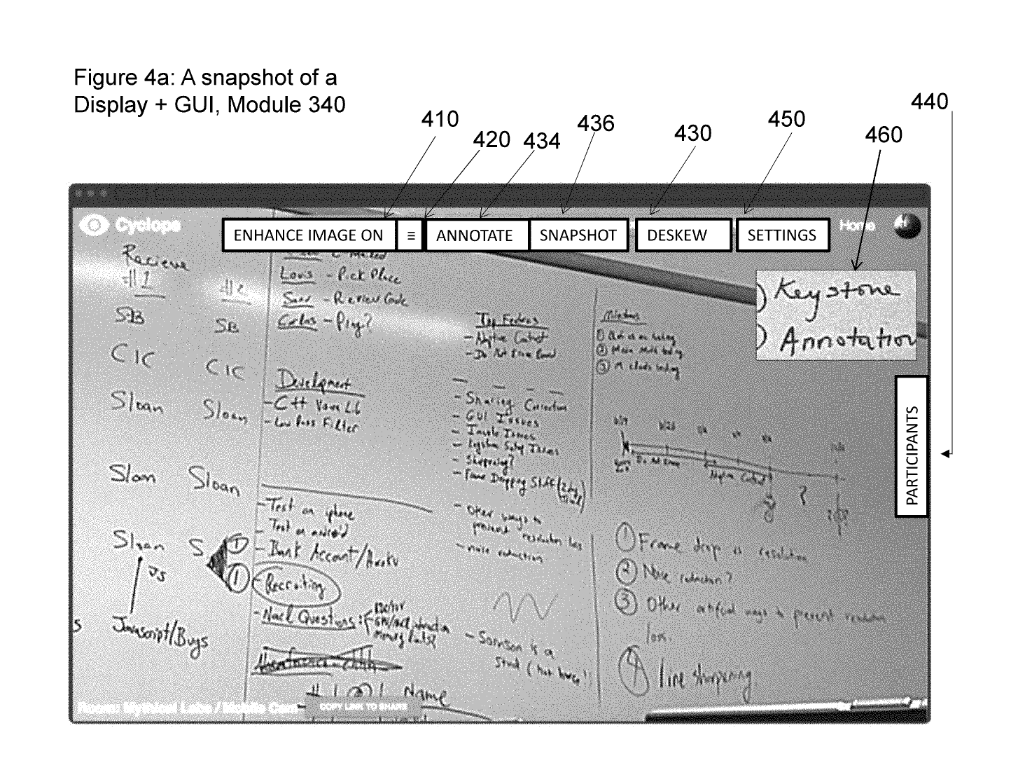

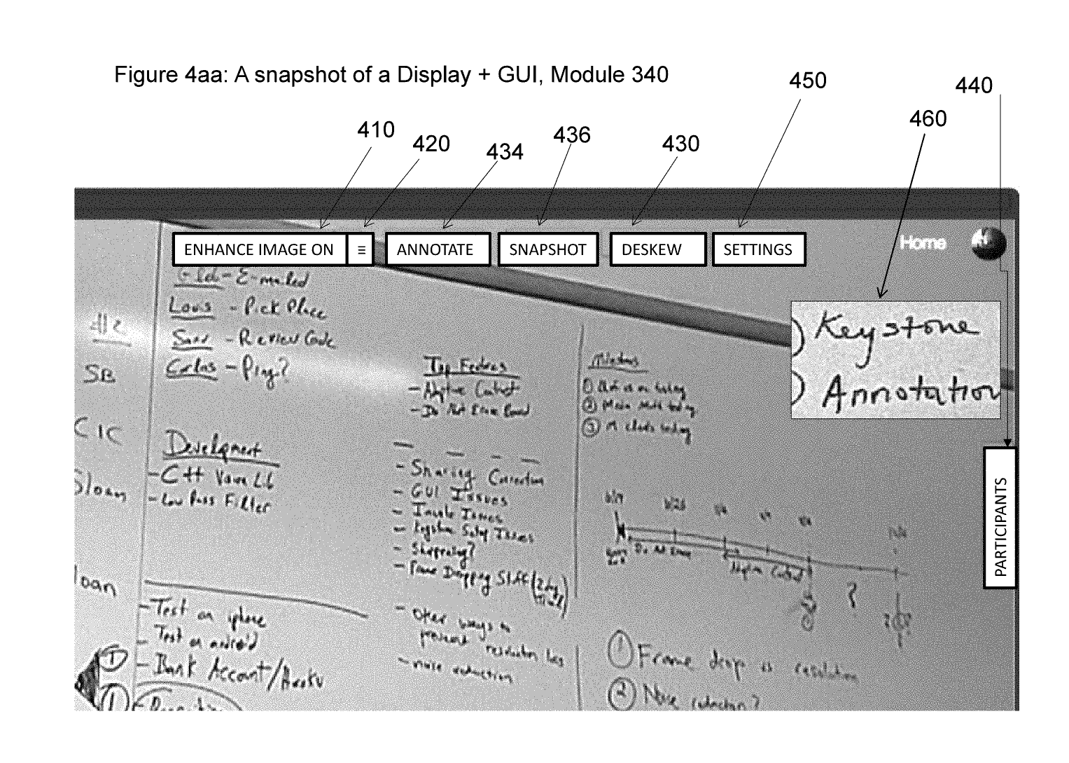

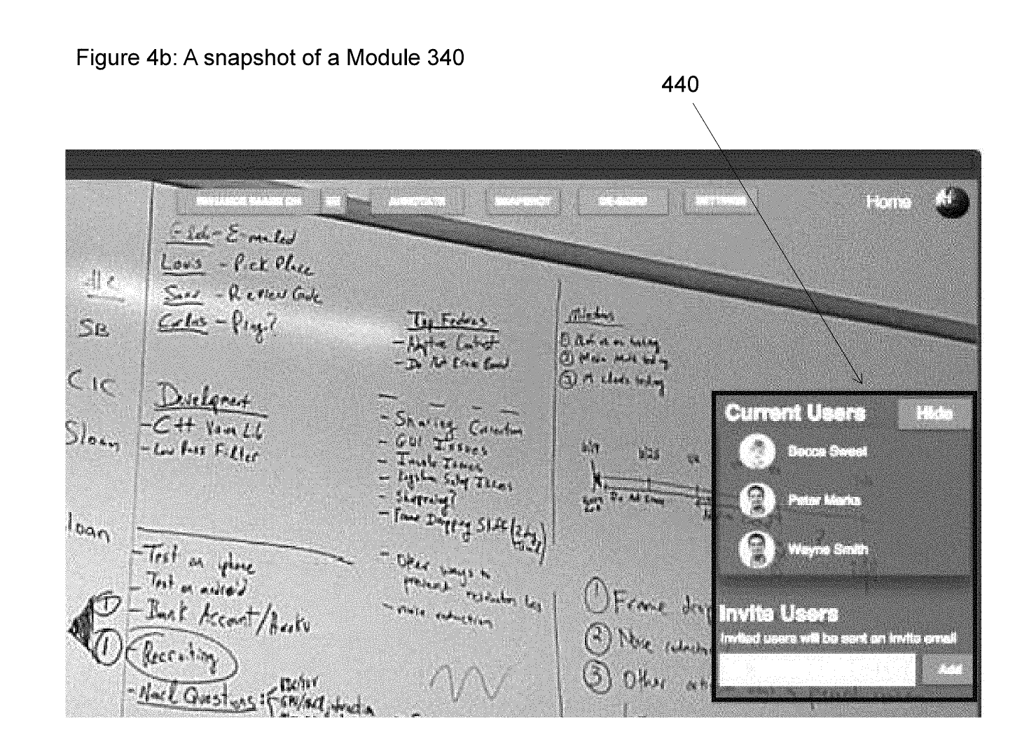

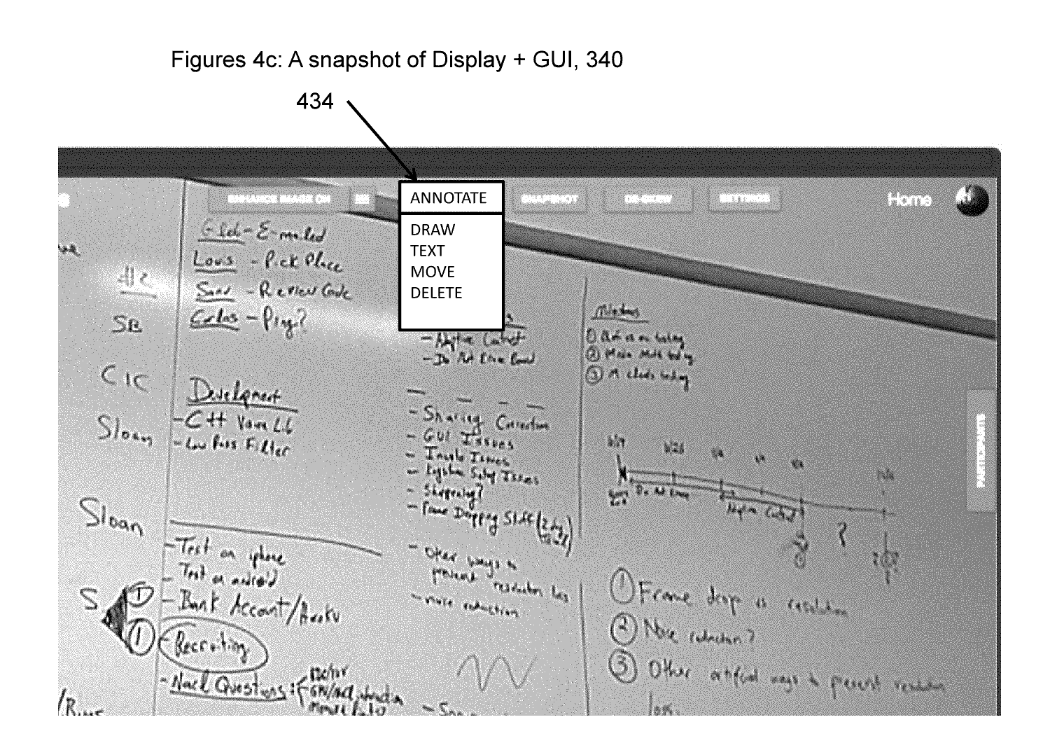

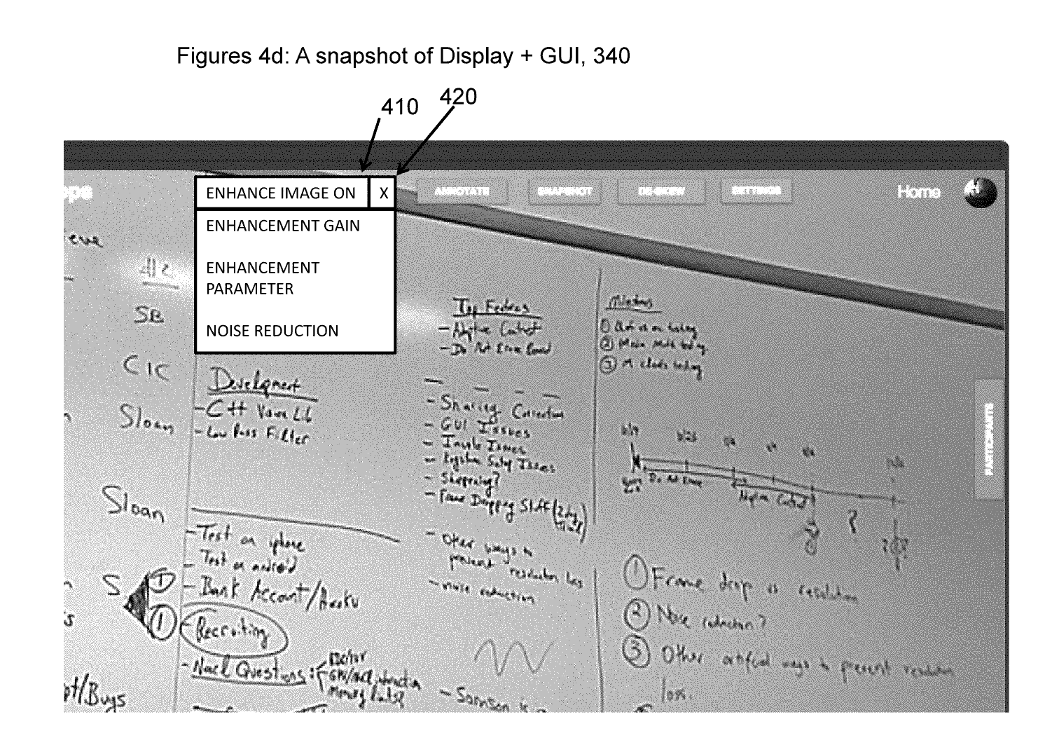

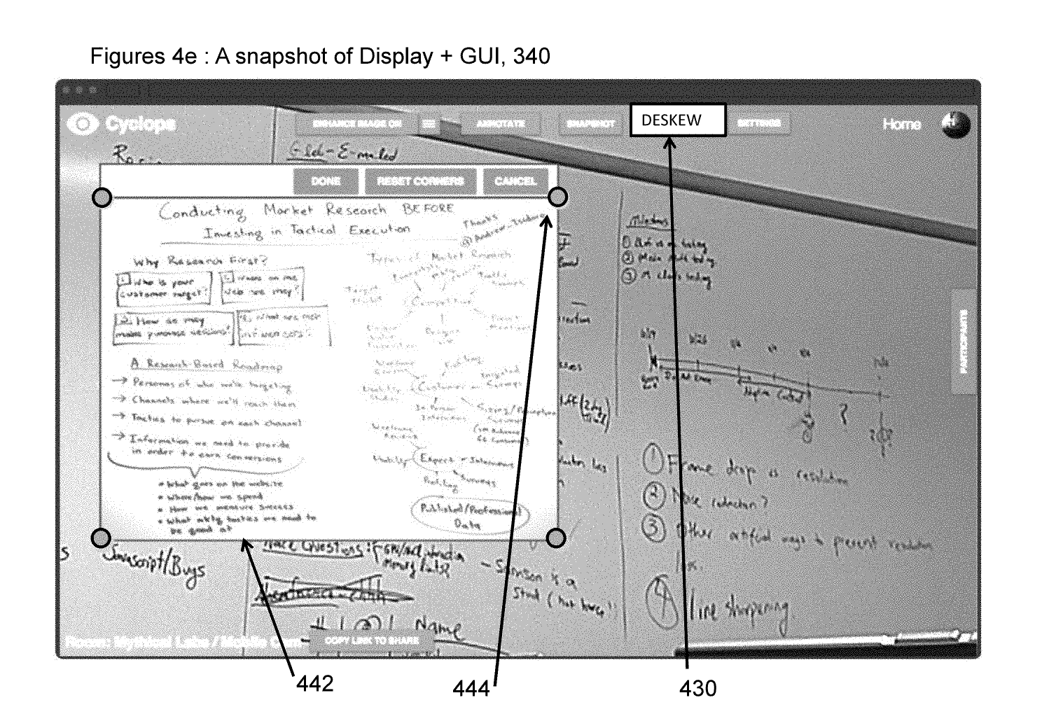

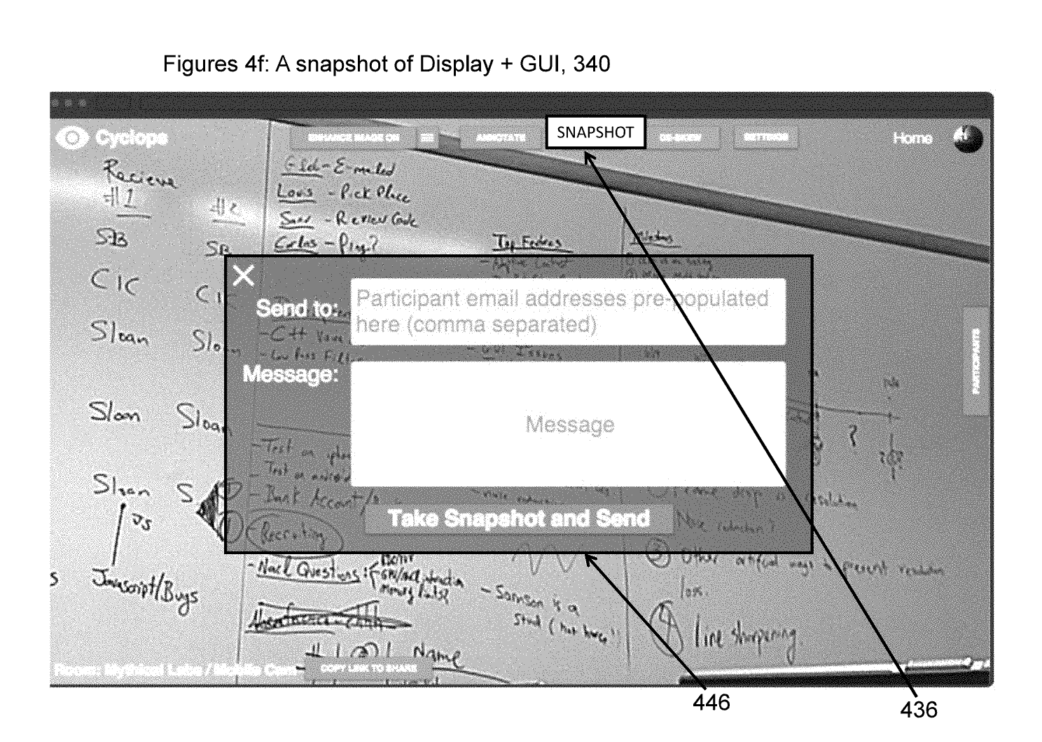

FIG. 4a is a snapshot of an exemplary GUI in accordance with an embodiment of Module 340 invention. FIG. 4aa is the same snapshot, zoomed in. The snapshot shows exemplary buttons and video. The video is shown in a large rectangle on 450. That video could be from a video camera, or from archival. It could potentially be a still image being shown repeatedly. Smaller window 460 often shows a zoomed in portion underneath where the mouse is located. It could instead show video/stills from other users writing surface, or from the archives. Button 410 gives the user the opportunity to turn off the correction to the image. The button is labeled ‘Enhance Image ON’. If the system is confident enough that the surface being shown is known, in this case a whiteboard, the button label can change to ‘Whiteboard enhancement on’ or similar. There is a dropdown button 420. Button 420 is a dropdown that allows users to tweak the parameter settings should they desire it. Button 430 allows for correcting the skew, and either sending it to users or archiving it. Button 434 allows access to the annotation menu. Button 436 allows access to saving the current frame and potentially e-mailing it. Button 440 opens up to indicate who is currently part of the session, and allows inviting people. A smaller exemplary GUI is shown in the bottom right, indicates the users in the room. The button 440 expands into a larger window that lists the users in the room, which is shown in FIG. 4b.

The overall system is often referred to as a virtual room, as it is a place where a number of users come and share data. In this case, the data being shared includes video and stills, typically processed, history, annotations.

FIGS. 4c, 4d, 4e and 4f shows a snapshot of the same exemplary GUI four times, each with some of the dropdowns expanded. In FIG. 4c, button 434, the annotation button, has been clicked on and a dropdown has appeared. The dropdown gives users the ability to draw, to add shapes, to write text, to move and delete annotations. In FIG. 4d, button 410 is indicated. Button 420 has been clicked on and a drop-down has appeared. The button has also changed to an ‘x’ to indicate clicking again will close the dropdown. The user can change the gain of the enhancement, the parameters on the enhancement and the noise reduction levels. That is, the user can override the automatically chosen parameters.

In FIG. 4e, button 430 is indicated again. The user clicks on it and a pop-up window appears 442, which typically shows the image. Four disks 444 are shown. The user can move the disks to indicate the corners of the whiteboard to be shown. The correction to the image can then be calculated in real-time using a 4×4 perspective matrix, commonly used to do skew correction. The transform is often called a homography. Note that one can do radial distortion correction on the lens should that correction be desired. The homography, and therefore the location of the points can be calculated automatically by segmentation of the whiteboard, and looking for extreme four corners. Additionally, as known in the state of the art, the methods of vanishing points can be used to choose a rectangular region, which is the most common case. Radial distortion can be estimated by looking at the deviation of lines in the image that are expecting to be straight from straight lines. Typically the edges of the drawing surface are used if available.

FIG. 4f shows button 436 again, and window 446 that appears from clicking on button 436. The window 446 gives users the ability to take a snapshot and send it to users and/or archive it. Typically, the recipient list can be automatically filled from user presence detection, e.g. knowing the users in the virtual room. Note that the message can include hashtags, such as ‘#WeeklyDevelopmentMeeting’ which make search through archival for the correct meeting much easier. It also allows the archival system to automatically group data with a related hash-tag.

FIG. 5 shows a block diagram to describe an exemplary video capture, processing, and transmission module 310 in accordance with an embodiment of the invention. The curved dash line around much of the diagram indicates what part of the diagram is 310. Initially the video is captured. The processing of the video is done in one of several places. In module 520, the module is optionally processed. Part of the processing may be to determine that the parameters of the camera (e.g. gain, offset, color space) need to be changed and to use the feedback loop 515 to send those parameters to the camera. This feedback loop most commonly happens when the camera is oversaturated, and the gain needs to be lowered.

Step 530 is the encoding step. The video is encoding for transmission. Feedback loop 535 communicates to the video processing step. The two steps often share resources, typically a CPU and a GPU. In the event that the encoder is at risk for not completing the encoding in time to process the next frame in real time, that information can be communicated to the previous step to adapt. The encoder can also indicate/measure any artifacts that are introduced with the encoding, and report those to step 520 to adapt.

In step 540, the video data is transmitted via the network. In step 545, the transmission step can report back that the bandwidth available is at risk of being overwhelmed.

The video may be sent peer-to-peer. Or, in step 550, the data can optionally be received and re-transmitted by computers 213. The video may also be processed in this step. One of the advantages to relaying the data is that available bandwidth can be used to transmit once, and the relay computer can relay to multiple devices 211, and to other relay computers 213 and then on to the devices 211. The total system can ensure it has enough bandwidth.

Note that sometimes one device 211 will have surplus processing power and bandwidth. In this case step 550 might be done by one of those devices 211.

The receiver will receive the data in 560, and decode the image frames in step 570. In step 580, the data will optionally be processed. Step 520, 550 and 580 can share the work, or the work can be distributed among the three steps as processing time allows. Not shown, steps 580 and 550 can report back to step 520 the available processing power to optimize where the processing is done.

Note that for the local display of data, step 520 can go directly to step 580; that is, there is no need to transmit the data.

The video can then be displayed at 590, which is an instantiation of module 340. and can be archived 592, an instantiation of 330.

FIG. 6a shows an exemplary flow diagram for the annotation module, 320 which is indicated using a dashed box. The first step is 610, to create annotations. Annotations coming in several forms. They may be a single user sharing a mouse with another user. In this case, the annotation is effectively fleeting. Another kind of annotation is a lasting annotation such as text, or a drawing or a shape. It is effectively a dot or shape that appear for a short period of time and disappears.

In step 620, the annotation module can optionally inform the video module that parts of the image are being covered up by annotations. Those regions need not be processed or transmitted. In step 630, the annotations are transmitted from one device to another, such as devices 211 and computer 205, or to the archival system to be archived 632. The annotations are then displayed, most typically on top of the video, 634.

Sometimes, cameras will move. After the motion, the annotations are out of place. The video module, for example part of the processing video step 520 for example, can report motions to the annotation module. In step 636, video stabilization algorithms are run.

Video stabilization algorithms are well known to those in the state of the art. One often runs a feature detector in an image, looking for corners and shapes for example, and then tries to find a feature in the new image in a similar place. Since writing surfaces are most typically planar, one can look for a homography as a transform from one image to the next.

The cameras that are used are typically fixed, or fixed for long periods. For example, the camera in a laptop, or as part of a webcam, or as part of a tablet can be positioned and will typically remain in place for long periods. Occasionally the camera will be moved, causing a large change.

FIG. 6b shows some of the annotations being displays. 650 in FIG. 6b shows an example of a drawing; someone has circled an item. Item 660 shows an example of a box and arrow. Item 640 shows an example of text annotations. Fleeting annotations, such as mouse movement, are not shown.

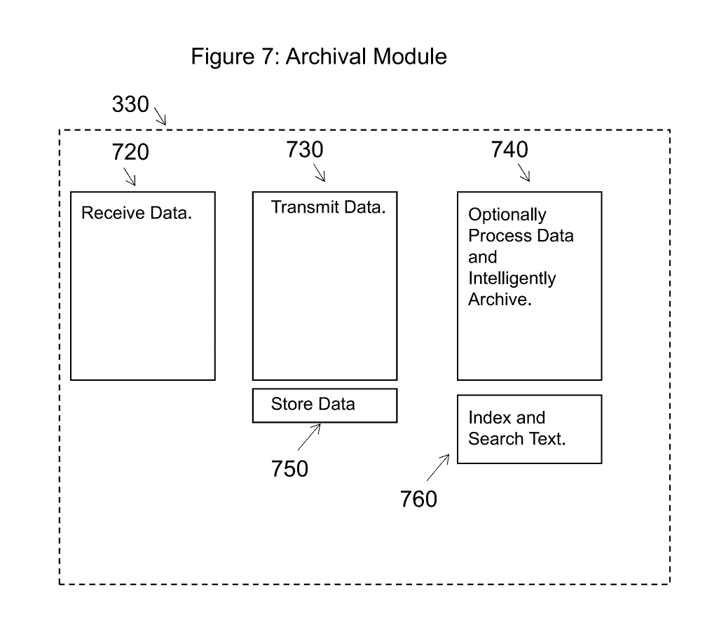

FIG. 7 shows a block diagram illustrating an exemplary instantiation of the archive module 330. The module 330 is labeled with a dashed line. A key part of the module is to receive data, 720. That includes video, annotations, screen-captures and key still frames, skew correction parameters, hashtags, meeting descriptions, attendees, meeting times, etc. Clearly a second key part is to transmit the data 730 to the devices and users in the virtual room. That includes data from this virtual meeting as well as part virtual meetings. Another part of the module is to store the data 750. Often it is stored in a database. Another part of the module is to index and enable search through the text data that is stored, 760.

Step 740 involves video processing of the data, as part of a decision process to store the data. For example, the archival system may be configured to store a frame once a minute. An alternative is to look for key-frames. For example, if the whiteboard is erased, storing the last frames before erasure is beneficial. To detect erasure, one is looking for large changes in the number of pixels that are represented as writing. One can use the backgrounding algorithms already described, and look for large changes in the number of pixels labeled as writing. Or, one can use a writing detectors previously mentioned, and look for changes in the number of pixels.

Rather than detecting erasure, the video processing system can also detect the addition of writing. The system can track the number of writing pixels added in time. When there is slow down in the number of pixels added per unit time, a frame is archived. In practice, we find that people stop writing for at least 30 to 60 seconds, if not longer, for discussion. During that time the number of writing pixels added goes to 0, and that is one situation where archiving a frame is reasonable.

Another example of video processing is piecing together frames. For example, if an obstruction such as a human moving from one side of the surface to the other, the system can detect that part of the whiteboard that was not previously visible, is now visible. The system can therefore piece together different frames to get a complete snapshot of the whiteboard. Detecting obstructions is relatively straight forward using background algorithms together with region detection algorithms. It's also straightforward to store known parts of the frame, and fill in pieces when new data becomes available, or it changes.

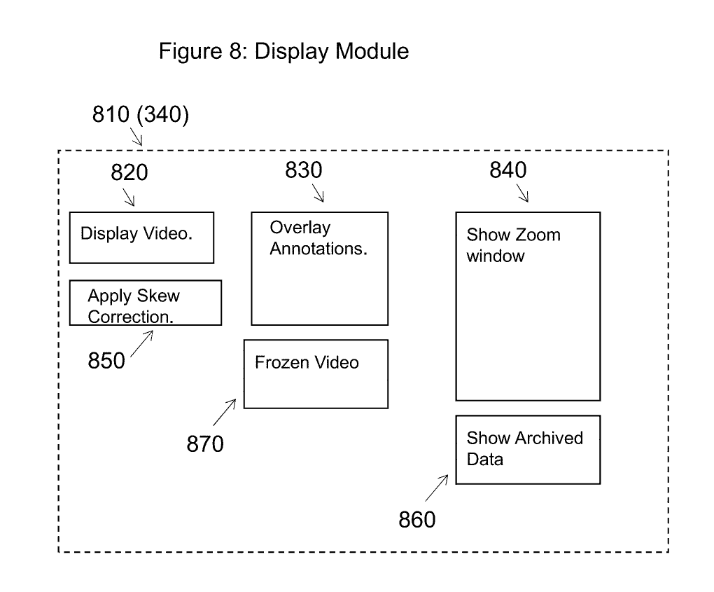

FIG. 8 shows a block diagram of an exemplary display module. Element 810 is part of element 340. The module displays video, 820. It applies the skew correction to the video if there is one, 850. It overlays annotations, 830. It can show the zoom window, 840. It can show archived video and stills, 860. It can show frozen video. A common use case is that the video is not changing at all. The user can indicate or the system can automatically detect that the video is not changing, and mark it as frozen, 870. This allows the system to provide further processing to the image and improve it as the restraints on computation time are much lower.

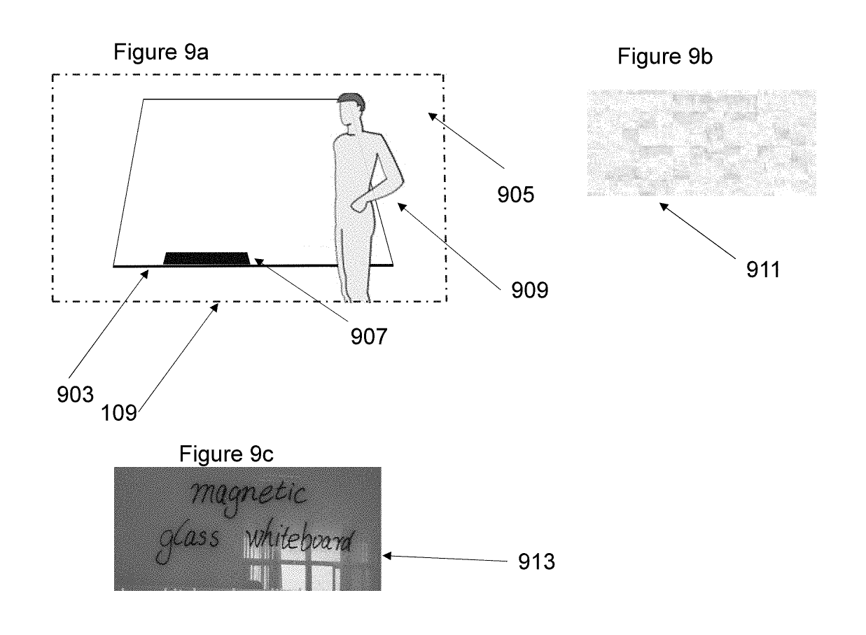

FIGS. 9a, 9b, 9c shows some of the factors that affect the quality of the image. FIG. 9a shows skew. Image 109 represents the image captured by the camera; the same region is shown in FIG. 1. The writing surface imaged 903 is skewed in the video. Note that other types of skew such as radial distortion from the camera lens are also possible. Region 905 is the region captured by the camera that is outside the viewing surface. Most often, it is not of interest.

Another type of artifact is an obstruction such as 907, which represents a whiteboard eraser or 909, which represents a human. Some obstructions, like the eraser, change very rarely. Other obstructions, like humans, move a lot. Both pose challenges to image processing algorithms.

FIG. 9b shows compression artifacts. The image 911 was blown up from a region of an image that is approximately uniform intensity. The square-regions are typical examples of the type of artifacts introduced by compression. Note that due to noise, the compression artifacts change at every frame. This causes an effect that is very noticeable to the eye, and highly distracting. A key goal is to minimize the noise. Another key goal is to keep that noise changing very slowly or not at all, in order to minimize distraction.

FIG. 9c shows a photograph of a glass writing surface that has glare. The portion of the image pointed to by 913 is an increased brightness caused by light coming through a window. If one looks carefully, one can see the outline of the window. Glare is also commonly caused by lights in the rooms, and is often seen on specular writing surfaces such as glass, whiteboards, whiteboard paint on wall such as IdeaPaint from IdeaPaint Inc. (Boston, Ma.), etc. Note that what can make the glare particularly challenging is that it changes with time. In general, lighting effects and shadows in the room will change with time.

There are other types of challenging intensity and color artifacts. For example, camera lenses often have intensity fall-off so that the intensity at the center of the image and the intensity at the edge of the image are often not uniform. Also causing intensity artifacts are shadows that are quite common on whiteboards, often caused by obstructions of light sources in the room. Similar to intensity artifacts are color artifacts. For example, lenses can treat colors differently so that images might, for example, appear more yellow at the edges then at the center. In fact, spatial distortions can be per-color as well. Sometimes, there are chromatic aberrations as well where the colors emanating from a single object on the wall land on the sensor in different places. The lens often causes this type of issue.

Another type of artifact that one often sees is halos. The camera data is processed coming out of the camera, often to compensate for lens reduction in high spatial frequencies, and the processing creates artifacts, which often appear as halos around sharp objects.

Another challenging issue, not shown, is camera motion. If the camera is permanently mounted, it may vibrate a bit. If it is sitting on a table, the camera may be nudged, or it may fall over. In these cases, any per-pixel memory of a correction system can be rendered inaccurate when the camera is re-positioned.

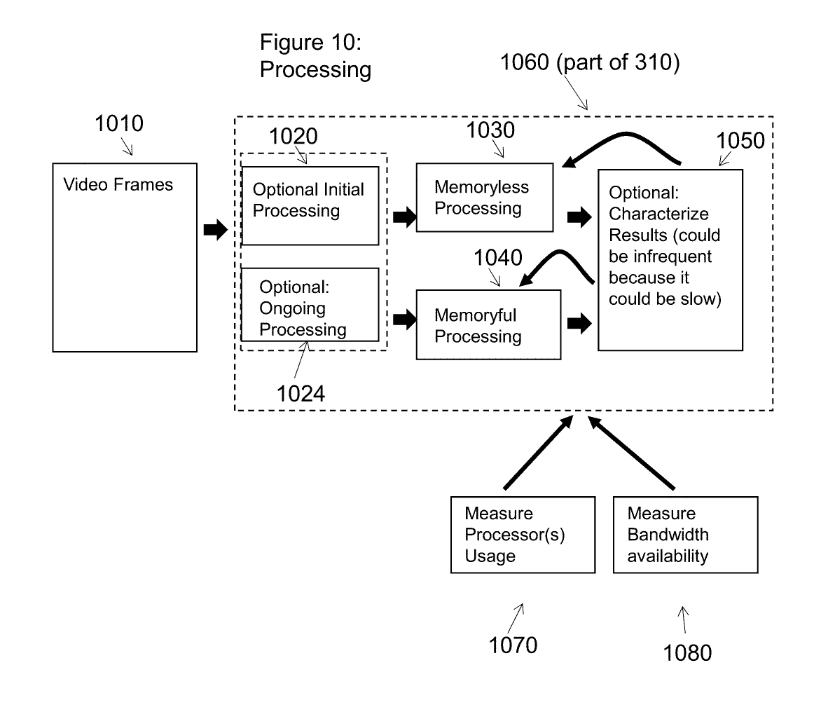

FIG. 10 shows a block diagram of an exemplary implementation of the Process Video step, which is part of step 310, and in practice is distributed across the 520, 580 and part of 550 from FIG. 5. The images frames 1010 are handed into the process module 1060. The first step is an optional initial characterization step, 1020. In this step, the system can be characterized, such as the input/output curve of the camera system or the noise statistics of the system, as well as the type of writing surface, or the region of the image that the writing surface encompasses. They may also record the intensity of the whiteboard for processing later. These calculations may be too slow to do in real time, so that doing that initially, often before the video is shown, is preferred.

Not only can there be initial processing, there may be ongoing processing 1024. The ongoing processing can check for the gain of the camera or motion of the camera or change in lighting. It may re-do the initial processing periodically, or when motion has happened or lights have moved. The goal is to check for potential changes that can affect future steps, particularly step 1040, the memory-ful processing.

The processing is then divided into memory-less 1030 and memory-ful 1040 processing. The distinguishing factor between these two is driven by whether they can be done in real-time.

Step 1030 is memory-less processing. Memory-less process takes the prior few frames and process them in real time to get a result. If there is motion, the algorithms may produce strange results during the motion or immediately thereafter. That said, once the system has processed the last few frames after the motion, there are no additional artifacts.

Step 1040 is memory-ful processing. Memory-ful processes use an intermediate calculation, typically because the calculation can't be done in real time. The intermediate calculation is stored in memory. These processes are typically per-pixel calculations that change significantly if the camera or obstructions move. For example, calculating the region of the whiteboard in the camera image may be too slow to do in real time. That calculation is affected if the camera moves. And, calculating per-pixel corrections to whiten the image is affected if the camera moves, or the obstruction moves. These steps are often too slow to be calculated in real-time. They may also require many frames of memory, such as backgrounding algorithms.

In step 1050, the results of the processing can be optionally characterized. The results may be too noisy, and the parameters of the algorithms can be tuned based on the results. Sometimes it is better to do this step after transmission, e.g. as part of step 580, so that the results are seen after decoding and transmission. While most often the characterization step goes back to steps 1030 and 1040, they can also sometimes feedback into steps 1020 and 1024.

Examples of the feedback loop 535 and 545 are 1070 and 1080. In 1070, the processor usage is fed back into the processing 1060. The available bandwidth 1080 is fed back into the processing 1060. The algorithms can be adjusted based on the available bandwidth and processing availability.

A key algorithm for memory-ful algorithms is detecting camera motion. There are numerous ways to do this. One method is to detect edges on the writing surface. Without camera motion, the edges are typically nearly stationary. An example of an algorithm to detect camera motion: For a new frame, consider many edge pixels. For each frame, for each pixel: if an edge is not where it was in the last frame, one can search a few pixels to find it. Count the fraction of edges not found within that search. If above a threshold, the camera has moved. Once motion is detected, the algorithm needs to be re-initialized with the new location of edges.

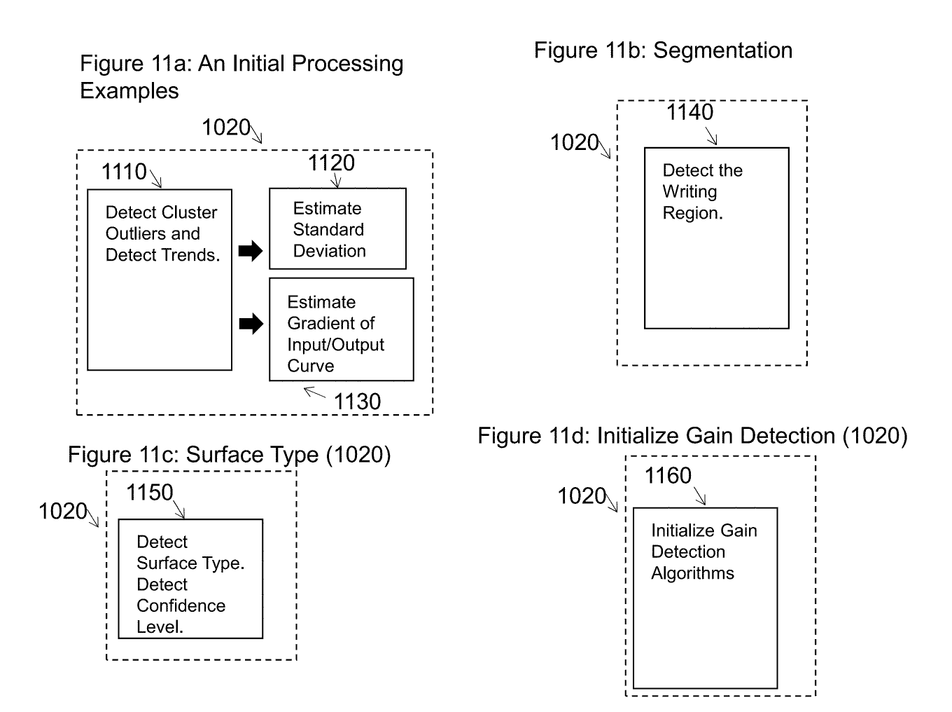

FIGS. 11a,11b,11c,11d shows a block diagram of an exemplary initial processing step 1020 to calculate noise and/or the input/output curve of the camera system. In step 1120, a per-pixel estimate of noise is formed using the standard deviation. Often, 20 frames are collected. To estimate the noise, it is desirable to collect the same measurement repeatedly at a frame. For each pixel, for each color component, an average is formed over time; the result is average image. One can estimate the standard deviation in the typical way: calculating the expectation of the square of the measurements minus the square of the expectation of the measurements, and then taking the square root. These methods are commonly used in statistics and are known in the state of the art.

If an obstruction such as a human moves in front of a pixel during this time, it causes errors in the measurements. This issue can be handled in several ways. First, one tries not to collect too many frames. At 30 frames per second, 20 frames for example, is two thirds of a second. In most cases, an obstruction such as a human won't move very much in that time scale. A second method is to use segmentation techniques. One can for example only estimate noise that use pixels that belong to the writing surface. Another method is to show a message in a window in the Graphical user Interface for a user of the system to remain still. If pixels are thrown away, the data for those pixels can be re-measured. Or, it can be extrapolated from other data.

One can also use clustering algorithms to look for outliers in the data, step 1110. For the example of collecting 20 frames, for each pixel, for each color, there are 20 measurements. One looks for and rejects outliers in the data as described in description of robust metrics. If too high a percentage of outliers are rejected, the data can simply be thrown away and re-collected.

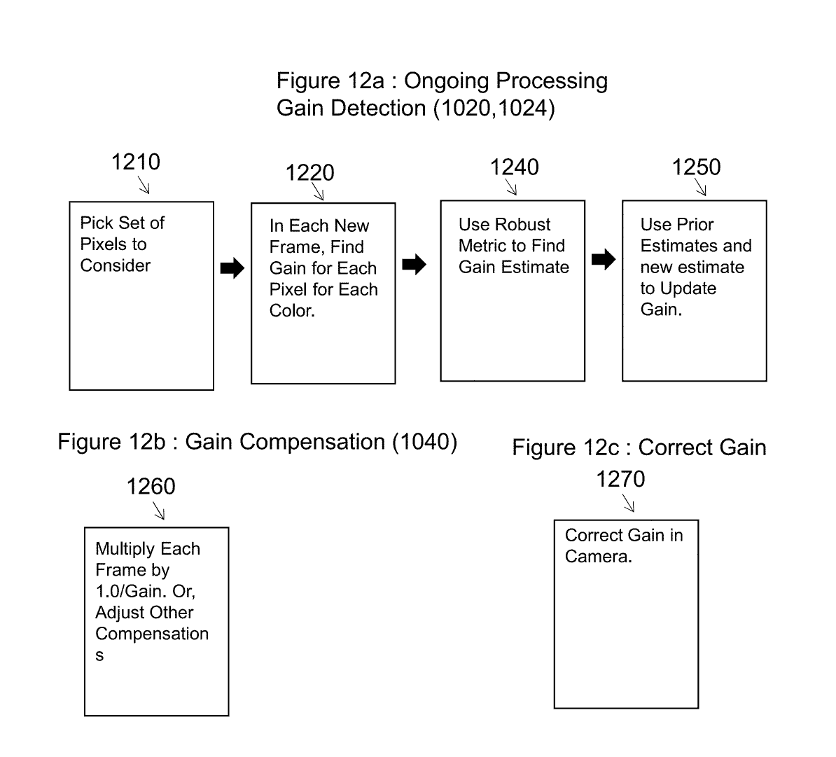

Another challenge is that in some systems, we may not have control over the gain of the camera. In this case, the input/output curve of the camera may change over time. One may monitor the camera and look for trends in gain. If the camera gain is changing, one can compensate for it. Or, one can simply throw away the data and wait for the camera gain to stop changing. Gain estimation is described in FIG. 12.

It's worth noting that for the measurements we have examined, the noise is not stationary across the image; it varies. In fact, our measurements show it depends on the intensity of the pixel. One model of the camera is that the light collection device does and corresponding analog to digital converter has approximately uniform noise across the camera. However, the system applies a formula similar to f(x)=[A x+B]̂(1/γ)+C, which x is the collected intensity, and A, B and C are unknown constants. The camera applies a contrast and brightness which is typically a scale factor such as A, and an offset such as B and/or C. The 1/γ power compensates for most screen which apply a roughly 2.2 power to the signal; thus gamma is typically about 2.2. Noise effectively changes the intensity x, by a small amount dx. The effect of the noise is approximately df/dx*dx. That is, the effect of the noise is magnified by the derivative of the function f′(x)=(1/γ)/[Ax+B]̂(1/γ−1). It is this effect that we actually measure, not the un-magnified noise. If one assumes that noise is uniform across the image, then the measurements we make effectively measure the derivative of the input/output curve of the camera, 1130. Our measurements have shown that the data closely follows a function like the above. It decreases with increasing intensity.

The estimates of noise are often quite noisy in themselves. There are many methods to decrease the noise in the estimates. The first is to fit a curve plotting noise against intensity. A second way is to average the estimates of noise with neighbors. A more precise way is to do that average without averaging with pixels with very different intensity. One can form a partial differential equation to solve for the noise that minimizes the squared difference between a pixel's noise and it's neighbors summed with the squared difference of the measurement of noise and the actual noise. The weighting of the first term can be inversely proposal to the intensity gradient between the pixels—a simple first difference. Such equations can be solved interactively usually typically non-linear gradient descent methods.

In FIG. 11b, the writing region is discovered. To find the writing region, step 1140, robustly is challenging. Most often, the region is nearly uniformly colored, is one of the largest items in the image, and is at or near the center of the camera. There are numerous segmentation techniques for a surface, typically based on measures of edges, and histograms of color and intensity and region-finding algorithms. In this invention, there is the addition of images in time, which allows the segmentation algorithms to be enhanced.

One effective segmentation technique uses find a measure of color, intensity, degree of edge, and noise at every pixel. The per-pixel intensity can be measured, for example, by summing the red, green, and blue (R,G,B) components of the pixel, if (R,G,B) is the color space. An algorithm to measure noise has already been done in 1120. Estimates for 1120 can be made without first detecting the region.

Two histograms can be particularly useful in finding the regions. The first is to form a histogram of total intensity. That is, for each intensity level, find the number of pixels with that total intensity. Often, there is a peak that is much larger than the rest. That's a good indication of the region of interest's intensity. A measure of the confidence is the difference in count from the largest peak to the next largest peak. When comparing those counts, it is important to include the effects of noise. A simple way to do that is to include counts not just from the peak bin, but from bins nearby whose intensity is within noise of that intensity. For robust algorithms, we often keep track of a few largest peaks in case the largest uniform image turns out to be in the background (e.g. a piece of paper on the table where the image of the table is much larger than the piece of paper.)

A second histogram that may be useful is the color histogram. One can plot 2d color histogram. For example, one can plot B-G vs. R-G, and look for maximums. Again, to get the counts right, one uses the measurements of noise to include neighboring bins.

Similarly, one can make a 3d histogram. One can instead plot a 3d histogram of (R+G+B, B−G, R−G) and look for maximums. Again, one looks in neighboring bins according to the effects of the noise. As before, a goodness measure is the difference in counts from the largest bins to the next largest bins.

The histograms are able to initialize algorithms of what colors and intensities are likely the colors and intensities of the writing surface. Additionally, the widths of those peaks can be measured as already described to find a sense of the variability within the region. Given that regions have intensity gradients, lighting gradients, etc. the width of the peak may be dominated by issues un-related to per-pixel noise. Thus, normalizing by a local intensity measure can be beneficial, such as the one from max/min morphological operator, or by running a low-pass filter across the image.

The next step is to connect regions using a region-growing algorithm. A simple way to do that is to find all the pixels that for a particular peak in one of the histograms, and use those pixels to start a region-growing algorithm. For example, connect the top, bottom, left and right neighbors of a pixel if the difference between that pixel and its neighbor falls within the width of the peak that is measured. A much more strict method is to use the noise width measured at each pixel, rather than the width of the peak.

The found region with the above region finding algorithms will include extra, undesirable regions. We therefore add a measure of the degree of an edge. One can form an edge-image as already described, and histogram the intensities in the edge-image. That image generally has a peak near zero, and a peak at much larger intensities. As one example, one can find a threshold in the middle, and not allow the region-growing algorithm to cross edges.

For each region, we expect the region to be convex, and so we fill in holes using usual methods. We can additionally look for straight edges as most writing surfaces are likely rectangular.

For each region, depending on the color, we may optionally additionally look for glare, large white patches within the region, or adjacent to the region.

For multiple regions, one can choose the region closest to the center of the image, or largest. Or, one can run a writing detector and choose the region with text in it.

Once the region has been chosen, the average color and intensity of the region can be used to identify a likely writing surface, such as whiteboard or blackboard; this is step 1150. That information, or the average color and intensity, can be used to choose optimal enhancement algorithms.

Another initial processing step is to initialize gain detection algorithms, step 1160 in FIG. 11d. Many cameras have automatic controls whose settings are difficult to control. Is this case, one may wish to characterize the input/output curve of the camera. A simple, computationally efficient way to do this is to select a number of points, and track them at every frame. One can start by finding the average values of the pixels at each frame in time.

FIGS. 12a, 12b, 12c shows an algorithm to accomplish the gain detection and application in more detail. In step 1210, points are selected which is part of step 1020. At step 1220, for each new frame, one can then compare the new pixel value to the old pixel value, part of step 1024. This step is part of the module 1024. One can keep the ratio for all the pixels tested, either by intensity or per-color. Using this kind of algorithm often leads to outliers as the obstructions can move, and writing can be erased or added to the whiteboard. One can therefore use robust metrics to see how much the gain has changed. As a simple example, one can form the histogram of the measurements as part of step 1240. One can then use robust metrics to find the gain. For example one use the median or mode of all the measurements. Or, can use clustering methods and fit a Gaussian to the middle values and use the center. It is often the case that the resulting estimate is noisy. One way to reduce the noise is to use prior estimates of the gain. One can average the measured gain g_m with the previous gain g_p to get a final estimate: r*g_m+(1−r)*g_p, where r is a number than varies from 0 to 1, depending on how slowly or quickly the gain is allowed to change.

One can parameterize the input/output curve as a spline, or with the parameters already mentioned: A, B, C and γ. Or, one can simplify and parameterize the curve as a contrast/brightness or a gain and an offset. Investigations show this simplification yield acceptable results for small gain changes. Independent of the parameterization, the gain measurement changes can be used as part of the enhancement. Gain compensation can be done such as in step 1260. If only a gain is being measured, one can just adjust each new frame by the inverse of that gain to keep the intensity of the writing surface uniform. Gain correction is often a part of 1040, memory-ful processing. If the camera moves, the gain correction algorithm is often reset.

Note that other cameras have gains that can be controlled. In this case, one is looking for changes in brightness in the room, e.g. the lights turning on, and detecting the change and intensity, and then feeding back the measurement to change the gain of the camera 1270 to compensate, rather than using the data as part of the correction.

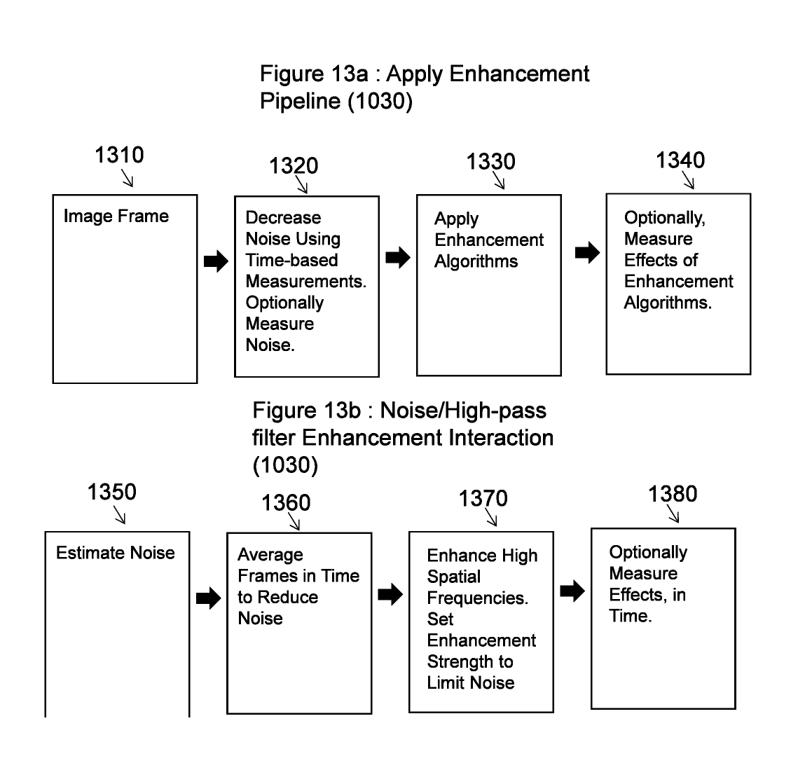

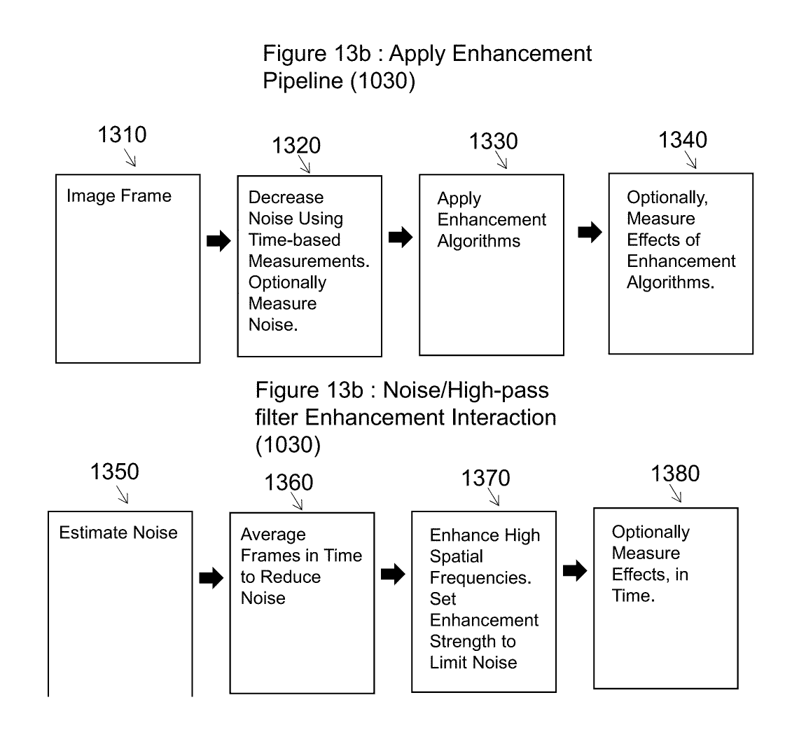

FIGS. 13a and 13b shows a family of memory-less processing, step 1030. One takes an image frame 1310, and feeds it into step 1320, a step to reduce noise. Often, one averages the frames to reduce noise. One can also use other methods more robust to outliers. If the step uses 20 frames, then the frame is held onto in memory for the next 19 frames. If averaging, the averaging step can be done as a simple average, or it can be done with a hamming window or other image processing window to reduce the temporal-aliasing effects, e.g. the trail an object might leave while moving across the video. Simultaneously in step 1320, one can estimate the noise within the video as already described. In 1330, enhancement algorithms are applied to the resulting frame. Note that the noise is not necessarily uniform across the video, so that the enhancement algorithms may be different across the display.

An example of 1330 is a high spatial frequency enhancement algorithm. A simple example of such a filter is to low-pass filter the image, using a Gaussian filter, for example, and then subtract the results from the original pixel. The result is a high-pass filter. One can take the results and multiply it by a parameter, and then add the results back into the original video frame. The result is a video frame whose high-spatial frequencies have been enhanced.

In step 1340, we can optionally measure the effect of the enhancement algorithms. That may be an algorithm to detect stray lines that are not part of writing, and their intensity, as well as the rate they are changing in time. These measurements can feedback information into the enhancement algorithms 1330 to keep the stray line intensity below a threshold. This is the feedback loop depicted in FIG. 10, 1050 feeding back into 1030.

FIG. 13b is handles the interaction between noise and filtering. In step 1350, one estimates noise as previously done using the per-pixel standard deviation. In step 1360, one reduces the noise through averaging. The noise is typically reduced by a 1/sqrt(n) effect, where n is the number of frames. One then enhances high-spatial frequencies in step 1370. The effect of the noise is enhanced by the high-spatial frequencies. And, because the noise varies in time, the effects of the noise, often appears as an artifact in one location that then jumps around to another location. The enhanced noise is visually very distracting. It is therefore important to keep its magnitude below a threshold. One way to do that is to predict the magnitude of the noise after the filter. That is relatively straightforward using digital filters by doing the calculation in the frequency domain as is commonly done in the state of the art. It is also possible to simply measure the noise after processing. Often, to set the parameters properly, one would like to measure the noise after compression and transmission, to account for artifacts caused by compression and/or transmission.

The key is that the noise levels in each camera are different, and the post-processing in each camera is different. One needs to adapt the filters to the particular camera/post-processing system to maintain a visual quality. Additionally, those estimates of the parameters in your camera such as noise affect the parameters in the segmentation algorithm, such as the histogram widths, and other image processing algorithms.

There are numerous methods for enhancing writing, and or edges. One family is to find the measure of the local degree of edge, and multiply it by a factor, and add the result back into the original image. Another mechanism is to try and whiten the image, and expand the difference in intensity between the darker regions and the lighter regions.

There are also numerous measures of edges, including digital filters, morphological operators, Canny algorithms, etc. The results can similarly by multiplied by a factor, and the result added/subtracted into the original image, or equivalently multiplied by the original image to enhance regions at edges.

Note that how one applies the algorithms is very dependent on the surfaces. Many of the methods above causing blooming artifacts. That is the area on one side of the edge gets darker, and the area on the other side gets brighter. For black writing on a white background, one generally wants to limit the blooming on the white background, while allowing the writing to be made as dark as possible. Thus, if one makes a filter whose result adds to the current image, one simply caps have large the addition can be to limit the blooming. On a dark background, such as a blackboard, one wants to do the opposite and limit the blooming for the dark background.

Another useful algorithm is whitening the image. In the region containing the writing surface, or perhaps the entire image, one finds a transformation to make the image look uniform intensity and color. For a white sheet of paper or a whiteboard, often that color is white, thus the term whitening. A simple way to do this is to estimate the color of a pixel, and normalize each color, and multiply by a constant value. If one uses this algorithm, the problem is one will erase the writing on the writing surface as well as everything else. A different method is to classify the pixels into writing, whiteboard, background, human, etc. One can then estimate what the correction is behind the writing, by erasing it, replacing the writing by its neighbor pixel values, and then low pass filtering the result to get a smooth correction image. Because of already discussed blooming artifacts that may part of the camera processing system, one often needs to erase a region around the writing by the expected width of the bloom.

There are two key challenges when implementing the algorithms. The first is that it computationally challenging to do segmentation in real time, for example 30 frames/second. That limitation is ok as the correction changes very, very slowly. Thus, one can compute a whitening correction in step 1020. One can then apply the whitening correction in step 1040, a memory-ful process. It is typically applied in the GPU or CPU. Periodically, one can recompute the correction in step 1024. And, one can check for motion of the camera and do a re-computation. And, similar, one can do gain correction for the camera in step 1024, which feeds information back into step 1040.

Image processing algorithms can use a lot of computational resources so that computational efficiency is of great importance.

One of the strong advantages of having imagery in time is that there are only a small number of regions where writing is likely to appear. One can divide an image into regions. The remaining regions need not be examined. One can effectively assign a probability for a region to change between frames, and only consider regions of the highest likelihood. Regions on the edge of the video, and regions near a human, e.g. large obstruction, have the potential to have writing added between frames. The regions neighboring those regions have a smaller probability. A simple algorithm is to start by examining the regions in a new frame where pixels are most likely to change. If they did change, then examine the regions around them. Within each region, the data can be considered hierarchically in a tree-like algorithm in order to be computationally efficient. Examining the region to see if any pixels have changed state can be done in many ways. Examining the pixels on the edge of a region is one method that works well; if those pixels have changed state, then check if the pixels in the interior have changed. One can also down-sample the image to check pixels, which also yields a hierarchical algorithm, as one up-samples for more detail and continue to check pixels.

Clearly, when encoding video to transmit, one can effectively determine that much of the image has not changed from one frame to the next, so that much of the image need not be re-processed for the encoding.

Sometimes, computational resources are limited, especially at the source computer 205. Luckily, there are other places the computation can be done, computers 213 and 211. Thus, it is possible to move some of the processing to other computers. For example, the results of step 1024, such as detection of the gain of the camera or checking if the camera has moved, can often be moved to other computers, and the results of the computation shared. Note that this process effectively trades off computation for bandwidth, as results need to be transmitted. Similarly, gain can be computed in many possible places.

In fact, gain need not be calculated at every frame. If the lack of resources on a computer is temporary, Steps 1024 and steps 1050 can often be dropped for several frames until a computer has more resources available.

Sometimes, some of the processing can be reduced. Digital filters and morphological operators can be run at lower length and smaller region size such that less compute is required. Similarly, some of the global estimates can be made to run faster by using fewer points to analyze. The steps to determine if the camera moved and determining if the gain of the camera changed can be estimated using fewer points. In these cases quality is traded off for computation.

For bandwidth issues, a key is that encoders are designed to most accurately transmit the video. For writing surfaces, that need not be the case. Video encoders typically work by presenting key frames, and then differences to subsequent frames until a new key-frame is transmitted. The objectives are therefore to make the key frames highly compressible, and to make the differences highly compressible. Most encoders use a hierarchical type scheme where the image is broken down into regions, and within each region, displaying more detailed changes requires larger representations. Thus, a good first step is a whitening filter. By applying the whitening filter to make the image uniform intensity and color, large portions of the regions are uniform intensity.

Noise reduction algorithms become very useful. Using frames in time to reduce noise is valuable, such as using averages, so that the changes between frames is small or zero. Often signal to noise ratio is a good metric for how distracting noise can be. In this case signal refers to the average intensity of a pixel, and noise the average standard deviation of the noise. The ratio can also be measured with the signal measured as contrast: the difference between the intensity of the background and the intensity inside the writing. Other time, other metrics can be used, such as the average size, intensity and count of spurious edges due the enhancement. (Spurious edges can be found by running region finding algorithms on enhanced edges, and then removing the edges that are classified as writing according to a writing detector.) The end result of reducing noise, no matter what its measure, is that the bandwidth required generally decreases.

Backgrounding algorithms become very useful. The pixels can be classified into writing, writing surface, background or obstructions. A noisy pixel that is in the same class as it was previously, can be replaced by the last known good value. The pixels therefore don't change values in time.

Regions outside the written surface need not be transmitted. They might either be cropped away, or replaced by a uniform background color such as black. Thus, a segmentation algorithm (generally a memory-ful algorithm) together with a camera motion detection algorithm to detect motion, allows the system to reduce required bandwidth. Or, those regions may be transmitted at a lower bandwidth, either refreshed at a lower rate, or transmitted at lower fidelity.

Obstructions such as humans are not important to the video of the surface. Humans can be segmented out, and either transmitted at a lower frame rate, or not at all. They can be replaced by the last known imagery of the surface in the region.

The writing itself can be enhanced to be easily compressed and transmitted. Making sharp edges is one way to do that for a standard encoder.

Exact colors in the writing surface may not be important. For example for a whiteboard, a version of the whiteboard that is white, and uses only a small number of saturated colors (e.g. red, green, blue) may be optimal. Moving obstructions such as humans may not need to be transmitted at all. One algorithm is to run a writing detector, and to change the colors of the found writing to the nearest primary. Thus, the image is effectively using a much smaller color space and need not encode many colors. Typically the color space is 3 colors, 256 values each, for a total of 16.7 million colors. Instead, one can switch to using gray values, and the 3 primaries only, which is 4*256=1024 values.

If bandwidth becomes very limited, not transmitting frames can be valuable.

Sometimes, computational resources are limited, especially at the source computer 205. Luckily, there are other places the computation can be done, computers 213 and 211. Thus, it is possible to move some of the processing to other computers. For example, the results of step 1024, such as detection of the gain of the camera, can often be moved to other computers, and the results of the computation shared. In fact, gain need not be calculated at every frame. Steps 1024 can often be dropped for several frames until a computer has more resources available.

Additionally, some of the processing can be reduced. Digital filters and morphological operators can be run at lower length such that less compute is handled.

A step that is very useful is when choosing regions to examine, raising the threshold of the probability of writing appearing, and thus examining fewer regions.

One can also trade bandwidth for computation. Rather than correcting the video before transmission, one can do the corrections after transmission

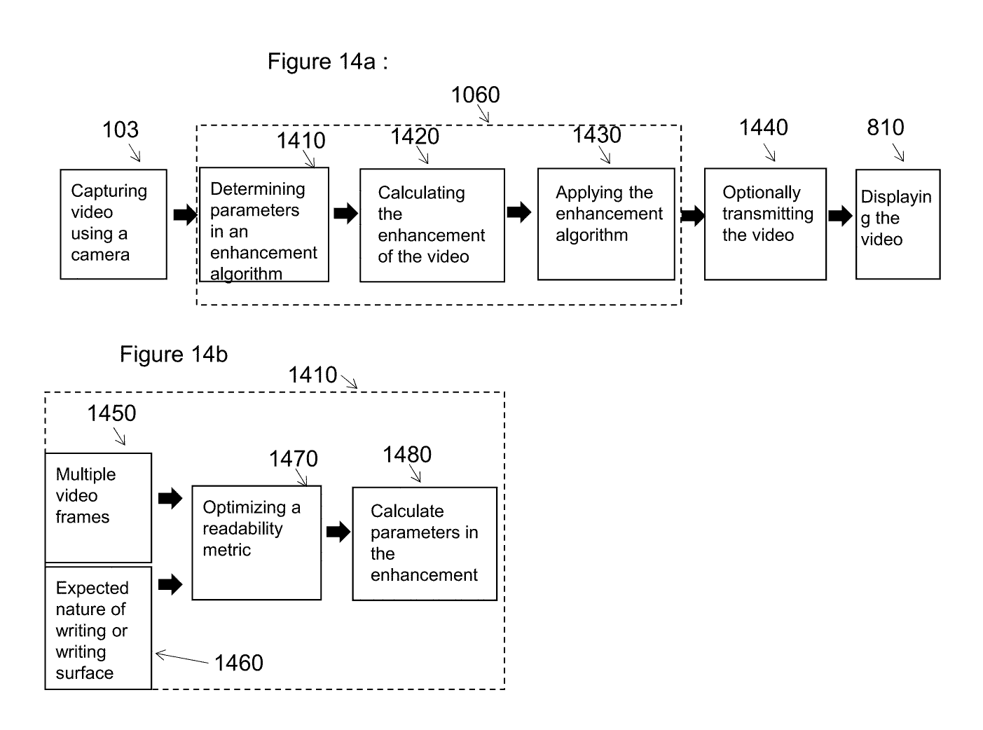

FIG. 14a shows an flow diagram illustrating an exemplary instantiation of the invention. In the first step, a camera captures video in. That is the same as step 103 in FIG. 1. The next steps are determining parameters in an enhancement algorithm (1410), calculating the enhancement (1420), and applying the enhancement (1430). These steps are an instantiation of module 1060 from FIG. 10. The video is then optionally transmitted (1440). The video is then displayed, which is module 810 from FIG. 8.

FIG. 14b shows a method of performing step 1410, determining the parameters in an enhancement algorithm. An algorithm is chosen (not shown) with parameters that can be tuned. The goal is to choose the parameters to optimize a readability metric. The calculation will use multiple frames from the input video, as well as the expected nature of the writing surface. In 1450, multiple video frames from the step 103 of capturing the video are used

For example, the readability metric could be the expected signal to noise ratio of the enhanced video. In this case signal means the difference between the intensity of the background of the surface, and the intensity of the writing. Noise refers to the magnitude of the noise.

The noise magnitude can be estimated per-pixel using multiple frames as already described, as well as estimated in the spatial frequency domain using standard techniques. A high-pass filter can be applied to the initial video, and the results of the high pass filter can be multiplied by a parameter and added to the initial video. The parameters of the high pass filter can be chosen to enhance the frequencies with maximum signal to noise ratio. Similarly, the multiplication parameter can be chosen to maximize the signal, without over-saturating. Once saturation is achieved, increasing the multiplication more would not increase the signal, only the noise.

The parameters of the high pass filter can also be adjusted for the expected nature and properties of the writing and/or writing surface. High pass filters can produce ringing effects near edges. For example, the region very close to the edge for a whiteboard might be appear extra bright on one side, and extra dark on the other side. For a whiteboard, the extra darkness is desirable, it increases the contrast between the foreground and the background. The extra brightness may not appear uniformly across all colors and thus cause a color shift around the writing. One way to adjust the high-filter is to introduce a parameter. If the results of the filter result in a darkening, it gets applied. If it results in a brightening, then the results are ignored. Clearly for blackboards, and glass different parameters are desired. As part of the determining the parameters of the enhancement algorithm, one can determine the type of surface as described in step 1150 in FIG. 11c.

Additionally, a low pass filter can reduce noise in time, which will also serve to increase the signal to noise ratio. A low pass filter that has the support of too many frames will introduce artifacts due to objects, typically humans, moving in front of the surface.

Other enhancements can similarly be made as described above, particularly as relating to FIGS. 10,11 and 12. For example, whitening filters can be added. Gain adjustments can be made, which need to be adjusted. The detection of the writing surface and writing can be done. Hierarchical algorithms can be used to enable real-time calculations. Or, the video can be divided into regions that are small enough to calculate the enhancement in real time, and a small number of those regions are calculated in real time.

### II. Alternate and Additional Embodiments and Examples

The following are particular examples of implementations in which the teachings of the inventive concepts herein can be employed.

Camera motion is an algorithm that can be particularly important to annotation. When the camera moves, one wants the annotation to move as well. Typically the writing surface is treated as a flat surface, and the goal is to measure a homography from the camera to the board. A simple way to find the transform is through a standard simultaneous localization and mapping (SLAM) algorithms. One periodically records a frame. One typically finds a set of image features with strong gradients, such as edges and corners. After motion is detected, a new set of features is found. The new features are matched to the old features using robust methods. The homography from the old to the new camera position can be found by matching those features. The resulting annotations can be mapped from their old positions to their new positions using the homography. In practice, one first runs the algorithm to determine if the camera has moved, and if it has, then runs the algorithm to find how far it has moved. Note that when computation is short, the number of pixels examined can be decreased, essentially trading off computation for quality. As more points can be gathered in the next frame, a low-pass filter in time can be added to achieve a low noise result that simply needs a few frames to converge.

One of the advantages of the invention is the ability to apply different enhancement algorithms to different regions or different classes of the image. For example, if the image pixels are classified as writing, writing surface, obstruction and background: one can apply a different enhancement on each. An edge-sharpening filter works well on the text. An intensity whitening works well on the remainder of the writing surface. Any obstruction such as people does not need to be enhanced to save computation and to not change the looks of the obstruction. The background need not be enhanced as well. Overall, different filters can be used in different classes of pixels as desired.

Compression artifacts have the potential to introduce sizable problems. Introducing corrections to pre-compensate for them can be valuable. The simplest way to do that is to make an image frame easily representable using a small number of compression basis functions. Whitening the image is the simplest way to pre-compensate for compression artifacts.

The foregoing has been a detailed description of illustrative embodiments of the invention. Various modifications and additions can be made without departing from the spirit and scope if this invention. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. For example, additional correction steps can be employed beyond those described herein. These steps may be based particularly upon the type of display device and display surface being employed. In addition, it is expressly contemplated that any of the procedures and functions described herein can be implemented in hardware, software, comprising a computer-readable medium consisting of program instructions, or a combination of hardware and software. Accordingly, this description is meant to be taken only by way of example, and not to otherwise limit the scope of this invention.

What is claimed is:

1. A method providing for an enhanced video of writing on a surface, the method comprising: using a camera to capture the video of the writing, calculating an enhancement to the video using an enhancement algorithm, determining the parameters in the enhancement algorithm to enhance the video, wherein the determining includes
(a) using data from multiple frames of the video in time,
(b) optimizing a readability metric, and
(c) calculating parameters in the enhancement algorithm using at least one of the expected nature of the writing and the expected nature of the writing surface to compute the enhancement;
applying the enhancement algorithm to the video, optionally transmitting the video, and displaying the video.

2. The method as set forth in claim 1 wherein the determining of the parameters in the enhancement algorithm includes measuring the noise in the video using the multiple frames in time as part of (a), and predicting the expected noise after enhancement as part of the calculation of the readability metric as part of (b).

3. The method as set forth in claim 1 where the readability metric is signal to noise ratio.

4. The method as set forth in claim 1 wherein the enhancement algorithms detects the type of surface and adjusts the parameters in the enhancement algorithm based on the nature of surface.

5. The method as set forth in claim 1 wherein the video is expected to be compressed (e.g. for transmission) and the enhancements are made to pre-compensate for expected compression artifacts.

6. The method as forth in claim 1 where a pixel's state as part of a class, such as a writing surface, writing, obstruction and background, and the enhancement algorithms are applied based on the classes

7. The method as set forth in claim 1 where the enhancement algorithms include making the writing surface appear uniform intensity and color.

8. The method as set forth in claim 1 where the enhancement algorithms include edge-enhancing algorithms.

9. The method as set forth in claim 8 where the enhancement algorithm includes a high-pass filters that enhances high-spatial frequencies.

10. The method as set forth in claim 1 where the enhancement algorithm includes low-pass filters in time.

11. The method as set forth in claim 9 where the enhancement algorithm includes a morphological operator.

12. The method as set forth in claim 11 wherein the video is divided into regions that are small enough to calculate the enhancement in real time, and a small number of regions are calculated in real time.

13. The method as set forth in claim 11 wherein regions are detected where changes in writing is likely and unlikely to occur and computational resources are dedicated to those regions where change is likely to occur.

14. The method as set forth in claim 13 wherein those regions are examined for changes using a hierarchical algorithm.

15. The method as set forth in claim 1 where camera motion is detected and memoryful algorithms are either updated or reset.

16. The method as set forth in claim 1 wherein the input output curve of the video is characterized using noise and is used as part of the determining of the enhancement algorithm.

17. The method as set forth in claim 1 wherein the input output curve of the video is characterized over time, and the enhancement algorithm parameters are updated to compensate for the changes over time.

18. The method as set forth in claim 17 wherein the enhancement is updated based on a characterization of at least one of the input output curve gain and offset of the video.

19. The method as set forth in claim 1 further comprising the step of detecting moving obstructions, such as humans, and removing them from the video.

20. A system for enhancing video of writing on surfaces comprising a camera to capture video, an enhancement algorithm to enhance the video, one or more computers to determine the parameters of the enhancement, and to apply the enhancement algorithm to the video, and optionally transmit the video, and a display to show the video, wherein the determining the determining includes (a) using data from multiple video frames in time, (b) optimizing a readability metric, and (c) calculating parameters in the enhancement algorithm using at least one of the expected nature of the writing and the expected nature of the writing surface to compute the enhancement.
